(19) United States
(12) Patent Application Publication
(10) Pub. No.: US 2004/0154170 A1
(43) Pub. Date: Aug. 12, 2004

(54) Releasable double locking knife

(76) Inventors: Charles L. Kain, Indianapolis, IN (US); Steven A. McCowen, Iola, WI (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/775,358

(22) Filed: Feb. 10, 2004

Related U.S. Application Data
(63) Continuation-in-part of application No. 10/141,150, filed on May 8, 2002, now Pat. No. 6,701,621.

(51) Int. Cl. B26B 3/06

(52) U.S. Cl. 30/161

(57) ABSTRACT

A releasable, double locking knife including a body having a cavity and a pair of opposed arms, each having a free end extending into the cavity, and a blade connected to the body for rotation between the closed position wherein the blade is disposed substantially within the cavity and an opened position wherein the blade is disposed substantially outside the cavity. The opposed arms engage side surfaces of the blade when the blade is in the closed position to resist movement of the blade out of the closed position. The arms further engage stop surfaces on the blade when the blade is in the opened position, thereby locking the blade in the opened position. The blade further includes a release mechanism for moving the arms out of locking engagement with the blade to permit movement of the blade out of the opened position.

### CROSS-REFERENCE TO RELATED APPLICATIONS

This application is a continuation-in-part application of U.S. patent application Ser. No. 10/141,150, filed May 8, 2002, which is expressly incorporated by reference herein.

### FIELD OF INVENTION

The present invention relates generally to knives, and more particularly to folding hand knives that are moved between a locked, opened position and a folded position using one hand.

### BACKGROUND OF THE INVENTION

It is known to provide knives that fold to a closed position and opened to an in-use position using one hand. Such knives, however, are configured to operate using either only the left hand or only the right hand. A left-handed knife, for example, is not operable using the right hand. Moreover, conventional, one-handed folding knives provide mechanisms for locking the knife in the extended position that are relatively easy to overcome, thereby compromising safety.

### SUMMARY OF THE INVENTION

The present invention provides a releasable, double locking knife that may be operated using either the left hand or the right hand. The knife includes a body and a blade pivotally connected to the body for movement between a closed position and an opened position. The body includes a pair of moveable arms that are biased toward one another into a locking position wherein the arms engage a stop surface of the blade, thereby locking the blade in the opened position. Additionally, the blade carries a release mechanism that is operated by the user with the left or right thumb. When the knife is in the opened position, the release mechanism is moveable toward the pair of moveable arms, and includes a pair of cam surfaces that urge the arms out of engagement with the blade, thereby permitting the blade to be folded into the closed position.

The features and advantages of the present invention described above, as well as additional features and advantages, will be readily apparent to those skilled in the art upon reference to the following description and the accompanying drawings.

### BRIEF DESCRIPTION OF THE DRAWINGS

FIG. 1 is a perspective view of a knife according to one embodiment of the present invention.

FIG. 2 is an exploded, perspective view of components of the knife shown in FIG. 1.

FIG. 3 is a partially fragmented, perspective view of a release mechanism according to one embodiment of the present invention.

FIG. 4 is a side, elevational view of a knife according to the present invention in the opened position with certain components removed for clarity.

FIG. 5 is a perspective view of the knife in FIG. 4.

FIG. 6 is a partially fragmented, top, plan view of the knife in FIG. 1.

FIG. 7 is a side, elevational view similar to FIG. 4, showing the blade of the knife moved slightly out of the opened position.

FIG. 8 is a perspective view of the knife shown in FIG. 7.

FIG. 9 is a top, plan view of the knife shown in FIG. 8 with all components shown.

FIG. 10 is a partially fragmented, perspective view of a release mechanism according to another embodiment of the present invention.

FIG. 11 is a partially fragmented, perspective view of a release mechanism according to another embodiment of the present invention.

FIG. 12 is a perspective view of a knife according to the present invention shown approximately halfway between the opened and the closed positions with certain components removed for clarity.

FIG. 13 is a perspective view of a knife according to the present invention in the closed position with certain components removed for clarity.

FIG. 14 is a top, plan view of the knife according to the present invention in the closed position.

FIG. 15 is a side view of a knife according to the present invention in the half-opened position with certain components removed for clarity.

FIG. 16 is a side view of a knife according to the present invention in the closed position with certain components removed for clarity.

FIG. 17 is an exploded, perspective view of components of a knife according to another embodiment of the present invention.

FIG. 18 is a partially fragmented, perspective view of a release mechanism of the knife of FIG. 17.

FIG. 19 is a partially fragmented, perspective view of the release mechanism of FIG. 18 with the knife shown in the opened position with certain components removed for clarity.

FIG. 20 is a partially fragmented, perspective view of the release mechanism of FIG. 18 with the knife shown in the opened position with certain components removed for clarity.

FIG. 21 is a partially fragmented, perspective view of another embodiment of a release mechanism of the present invention with certain components removed for clarity.

FIGS. 22-28 are perspective views of the release mechanism of FIG. 21 with certain components removed for clarity.

FIGS. 29(a) and 29(b) are side views of an alternative embodiment of a component of the knife shown in FIG. 22.

FIGS. 30-32 are partially fragmented, perspective views of another embodiment of a release mechanism of the present invention with certain components removed for clarity.

FIGS. 33 and 34 are partially fragmented side views of certain components of the release mechanism shown in FIG. 30.

FIG. 35 is a partially fragmented side view of a component of a knife according to one embodiment of the present invention.

FIG. 36 is a perspective view of a component of a knife according to one embodiment of the present invention.

FIGS. 37-39 are side views of a knife including the components shown in FIGS. 35 and 36 with certain components removed for clarity.

FIG. 40 is a perspective view of a component of a release mechanism according to another embodiment of the present invention.

FIG. 41 is a perspective view of a knife according to one embodiment of the present invention, including the component shown in FIG. 40.

FIGS. 42 and 43 are perspective views of the release mechanism shown in FIG. 41.

### DETAILED DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention.

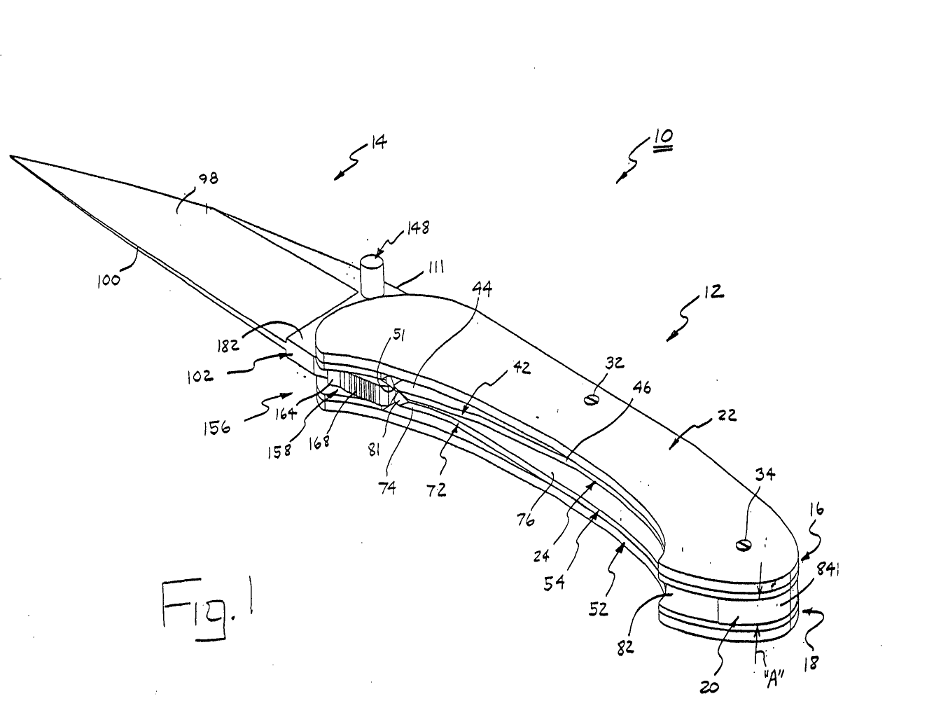

Referring now to FIG. 1, a releasable, double locking knife according to one embodiment of the present invention is generally designated by number 10. Knife 10 generally includes a body 12 and a blade 14. Although this specification refers to blade 14 as a means for cutting material, it should be understood that the teachings of the present invention may be applied to a variety of different foldable tools, and is not limited to knives. For example, blade 14 may be replaced with a screwdriver, a bottle opener, a corkscrew, or any of a variety of other different types of tools. Body 12 generally includes a first side 16, second side 18, and a spacer 20 and may be formed in the shape of a handle having curved outlines as shown, or formed in any other shape for gripping when blade 14 is in the opened position.

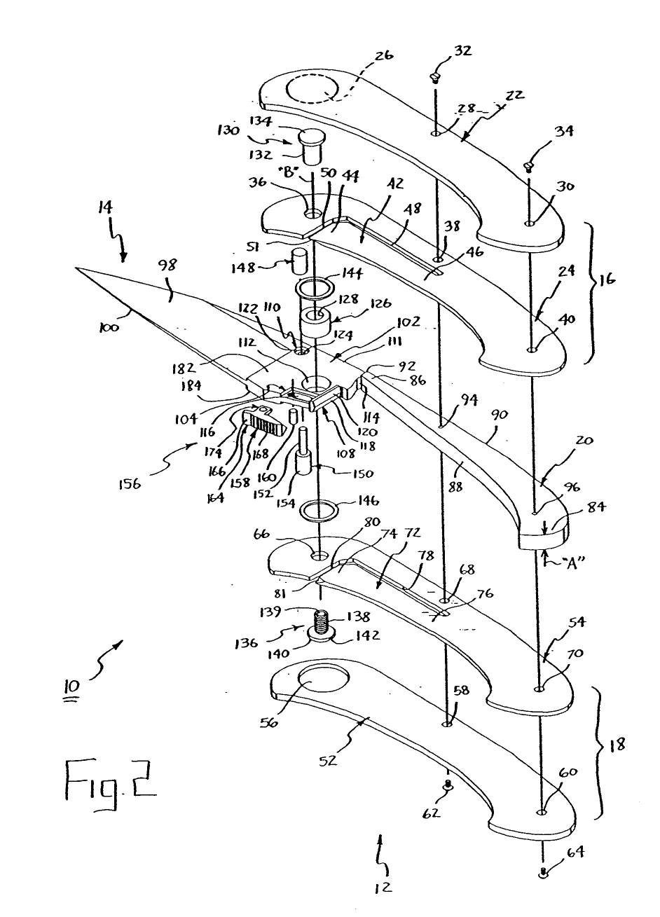

Referring now to FIG. 2, side 16 includes a scale 22 and a liner 24. Scale 22 includes a recessed area 26, and a pair of openings 28, 30 for receiving fasteners 32, 34 to connect side 16 to spacer 20. Liner 24 may be shaped as shown to have an outline that corresponds substantially to the outline of scale 22. Liner 24 includes a through hole 36 centered in a location adjacent one end of liner 24 that substantially corresponds to the center of recessed area 26 of scale 22 when liner 24 and scale 22 are connected together as will be further described below. Liner 24 further includes a pair of openings 38, 40 that similarly correspond to the locations of openings 28, 30 of scale 22 when liner 24 and scale 22 are connected together.

Liner 24 also includes a moveable arm, generally referred to by number 42. In one embodiment of the invention, arm 42 is integral with and formed as a part of liner 24. It should be understood, however, that arm 42 (and the opposed arm of side 18) may be separate from liner 24, but connected or otherwise coupled to liner 24 to operate in the manner described below. In the illustrated embodiment, arm 42 includes a first end 44 and a second end 46. Second end 46 depends from liner 24 while first end 44 (or free end of moveable arm 42) is moveable substantially into and out of a plane containing liner 24. Thus, in this embodiment, arm 42 may be formed by cutting a slot 48 into liner 24 as shown in the drawings. As will be described in greater detail in the description of the operation of knife 10, according to one embodiment of the present invention, arm 42 also includes an engagement surface 50 for cooperating with a portion of blade 14 to lock blade 14 in the opened position, and a cam surface 51 for cooperating with a release mechanism of blade 14 to permit movement of blade 14 out of the opened position.

As best shown in FIG. 1, arm 42 is bent or biased slightly downwardly (as viewed in the figure) relative to the plane containing liner 24. Thus, free end 44 and engagement surface 50 are disposed, when in a relaxed or locking position, out of the plane containing liner 24 away from scale 22. Liner 24 and arm 42 are formed, in one embodiment, of steel or other suitable material to provide strength and rigidity to body 12, but permit some flexibility of arm 42 such that free end 44 may be moved into and out of its relaxed position.

Side 18 is essentially a mirror image of side 16. Side 18 generally includes a scale 52 and a liner 54. Scale 52, like scale 22, includes a recessed area 56, and a pair of openings 58, 60 for receiving fasteners 62, 64. Liner 54, like liner 24, includes a through hole 66, and a pair of openings 68, 70 that are substantially aligned with recessed area 56, and openings 58, 60, respectively, when liner 54 is attached to scale 52. Liner 54 also includes a moveable arm 72 having a first end 74 (or free end) and a second end 76 that may depend from liner 54 in the manner described above with respect to arm 42. In this embodiment, arm 72 is formed from the material forming liner 54 by providing a slot 78 as shown in the figure. Like arm 42, arm 72 includes an engagement surface 80 and a cam surface 81. Free end 74 of arm 72 is disposed, in its relaxed or locking position, out of a plane containing liner 54 and spaced apart from scale 52. Accordingly, as will be further described below, when knife 10 is assembled, moveable arms 42, 72 are biased toward one another to lock blade 14 in the opened position, but may be flexed apart from one another to release blade 14 from the opened position.

Spacer 20 of body 12 has a thickness “A” that substantially corresponds to the width of a cavity 82 (FIG. 1) formed within body 12 for receiving blade 14 when in the closed position. Spacer 20 includes a first end 84, a second end 86, an inner side 88, and an outer side 90. First end 84 and outer side 90 are curved to substantially correspond to the shape of the outlines of scales 22, 52, and liners 24, 54 such that when all of the components are connected together as shown in FIG. 1, they form a substantially smooth profile. Inner side 88 tapers toward side 90 with distance from end 84 as shown in the figure to provide space for blade 14 when folded into the closed position and received by cavity 82. End 86 includes an abutment surface 92 that cooperates with a surface of blade 14 to limit the pivotal movement of blade 14 when blade 14 is moved to the opened position as will be further described below. Finally, spacer 20 includes two threaded openings 94, 96 facing liner 24 and two threaded openings (not shown) facing liner 54. Openings 94, 96 are located to align with openings 28, 30 of scale 22 and openings 38, 40 of liner 24, respectively. Scale 22 and liner 24 are connected to spacer 20 by inserting fasteners 32, 34 through the appropriate openings in scale 22 and liner 24, and threading fasteners 32, 34 into threaded openings 94, 96 of spacer 20. The other threaded openings (not shown) of spacer 20 facing liner 54 are similarly located to receive fasteners 62, 64 when fasteners 62, 64 are inserted through the corresponding openings of scale 52 and liner 54 to connect scale 52 and liner 54 to spacer 20 in the manner described above.

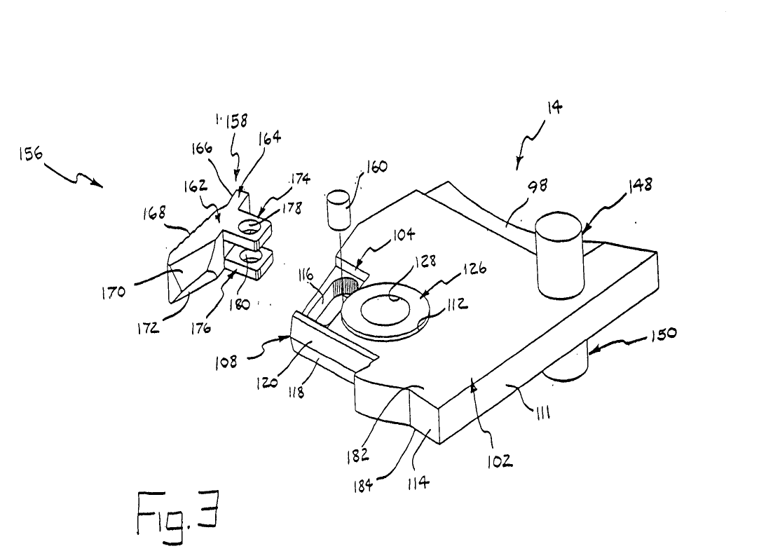

Referring now to FIGS. 2 and 3, blade 14 generally includes a cutting portion 98 having a sharpened edge 100, and a base generally referred to by the number 102. Base 102 generally includes a first side surface 182, a second side surface 184, a recessed portion 104, a wedge 108, a thumb stud opening 110 (FIG. 1), a pivot opening 112, and an abutment surface 114. As shown, recessed portion 104 is recessed into both sides 182,184 of base 102 to form a reduced thickness area, and includes a slot 116 for cooperating with a release mechanism 156 to release the knife 10 from its locked, opened position. Wedge 108 includes a pair of stop surfaces 118, 120 for cooperating with engagement surfaces 80, 50 of arms 72, 42, respectively, to lock blade 14 in the opened position, as will be further described below. It should be noted that stop surfaces 118, 120 form a substantially obtuse angle relative to one another that substantially corresponds to an obtuse angle formed by engagement surfaces 80, 50 when arms 72, 42 are in the relaxed position and biased fully toward one another. Thumb stud opening 110 is situated adjacent edge 111 of base 102, and includes a recess 122 into surface 182, a through hole 124, and a similar recess (not shown) into surface 184.

Pivot opening 112 is sized to receive a pivot bearing 126 which is substantially cylindrical and has a height that is slightly greater than the thickness of base 102 of blade 14. Pivot bearing 126 includes a central opening 128 that is sized to receive a pivot pin 130.

Pivot pin 130 includes a shaft 132 that has a diameter that is slightly smaller than the diameter of opening 128 such that bearing 126 can pivot about shaft 132. Pivot pin 130 also includes an enlarged diameter head 134. Shaft 132 of pivot pin 130 is internally threaded to receive the threads 138 of a pivot screw 136 having a threaded shaft 139 and an enlarged diameter head 140 with a slot 142 for screwing pivot screw 136 into shaft 132 using a screwdriver or similar tool. As will be further described below, a pair of spacers 144, 146, formed in the shape of thin washers having openings with a diameter that is larger than the outer diameter of pivot bearing 126, are positioned within body 12 to stabilize blade 14 and minimize side-to-side motion of blade 14 during use.

As also shown in FIG. 2, knife 10 further includes a first thumb stud 148 and a second thumb stud 150. First thumb stud 148 is substantially cylindrical in shape and has a threaded, internal opening (not shown). First thumb stud 148 has an outer diameter that substantially corresponds to the diameter of recess 122 such that first thumb stud 148 sits within recess 122. Second thumb stud 150 includes a threaded shaft 152 and a stud portion 154 having a diameter that substantially corresponds to the diameter of another recess (not shown), similar to recess 122, formed in surface 184 of base 102. Thumb studs 148, 150 are attached to base 102 of blade 14 by inserting shaft 152 of second thumb stud 150 through thumb stub opening 110 and threading shaft 152 into the threaded, internal opening (not shown) of first thumb stud 148. When shaft 152 of second thumb stud 150 is tightly threaded into the threaded, internal opening of first shaft 148, first thumb stud 148 is tightly drawn into recess 122 and lateral movement of thumb studs 148, 150 is prevented by through hole 124 and recess 122.

Finally, knife 10 further includes a release mechanism generally referred to by the number 156. As best shown in FIG. 3, release mechanism 156 generally includes an actuator 158 and a rod 160. Actuator 158 includes a body 162 with an end tab 164 having a stop surface 166, a ridged bearing surface 168, a pair of cam surfaces 170, 172 forming a wedge, and a pair of parallel tabs 174, 176. Tab 174 includes an opening 178 that is aligned with a similar opening 180 formed in tab 176. Release mechanism 156 is connected to base 102 of blade 14 by positioning actuator 158 such that parallel tabs 174, 176 fit within recessed portion 104. The distance between the facing surfaces of parallel tabs 174, 176 is slightly greater than the thickness of recessed portion 104 of base 102. Accordingly, tabs 174, 176 can move within recessed portion 104. Actuator 158 is coupled to base 102 by inserting rod 160 through opening 178 of tab 174, slot 116 of base 102, and opening 180 of tab 176. Rod 160 has an outer diameter that is slightly smaller than the width of slot 116 such that rod 160 is moveable along the length or axis of slot 116. Rod 160 may be press fit into openings 178, 180 or otherwise connected to tabs 174, 176. The path of travel of actuator 158 is substantially defined by slot 116 and the various surfaces of base 102 forming recessed portion 104. As will be further described below, actuator 158 is thereby moveable toward and away from arms 42, 72 along the axis of slot 116.

Referring back to FIG. 2, after release mechanism 156 and thumb studs 148, 150 are coupled to blade 14 in the manner described above, the overall assembly of knife 10 is accomplished by next inserting pivot bearing 126 into pivot opening 112 of base 102. Pivot bearing 126 is press fit into opening 112 and because pivot bearing 126 is slightly longer than the thickness of base 102 at pivot opening 112, the ends of pivot bearing 126 protrude slightly beyond side surfaces 182, 184 of base 102 as best shown in FIG. 3. The length of pivot bearing 126 is the same as thickness “A” of spacer 20. Spacer 144 is then placed on the protruding end of pivot bearing 126 and encircles pivot bearing 126. The thickness of spacer 144 is such that its outer surface (relative to base 102) is flush with the end surface of pivot bearing 126 when spacer 144 is placed onto pivot bearing 126.

Through hole 36 of liner 24 is then aligned with opening 128 of pivot bearing 126 and shaft 132 of pivot pin 130 is placed through hole 36 and opening 128. The partially assembled knife may then be flipped over while holding pivot pin 130 in place. Spacer 146 is then placed over the protruding end of pivot bearing 126 and through hole 66 of liner 54 is aligned with shaft 132 of pivot pin 130. Threaded shaft 139 of pivot screw 136 is then inserted through hole 66, opening 128, through hole 36, and threaded into the threaded, internal opening (not shown) of shaft 132. It should be understood by one skilled in the art that when pivot screw 136 is fully tightened into pivot pin 130, blade 14 may rotate about a rotation axis (designated by the letter “B”) extending through pivot pin 130, through hole 36, spacer 144, pivot bearing 126, pivot opening 112, spacer 146, through hole 66 and pivot screw 136. Moreover, the length of shaft 132 of pivot pin 130 is such that its free end is flush with the lower surface of liner 54 (as viewed in FIG. 2) so that when pivot screw 136 is fully threaded into shaft 132, head 140 engages the free end of shaft 132. This prevents pivot rod 130 and pivot screw 136 from impeding rotation of blade 14 by compressing liners 24, 54 against spacers 144, 146 and base 102 or against pivot bearing 126. While blade 14 is not compressed between liners 24, 54, the length of shaft 132 of pivot pin 130 and the thickness of base 102, pivot bearing 126, and spacers 144, 146 are such that blade 14 is prevented from wobbling side-to-side relative to liners 24, 54.

Spacer 20 may then be positioned between liners 24, 54 such that the threaded openings 94, 96 align with openings 38, 40 of liner 24. Scale 22 may then be placed onto liner 24 such that head 134 of pivot pin 130 is received within recessed area 26 and openings 28, 30 align with openings 38, 40 of liner 24, respectively. Fasteners 32, 34 are used to connect scale 22 to liner 24 and spacer 20 as described above. It should be understood that more than two fasteners (and corresponding openings) may be provided, or a single fastener may be used to attach the above-described components together. Also, one or more such fasteners may extend from one of scales 22, 51, through spacer 20, and connect to the other of scales 22, 52.

The threaded openings (not shown) on the other side of spacer 20 are also aligned with openings 68, 70 of liner 54. Scale 52 may then be placed on liner 54 such that head 140 of pivot screw 136 is received in recessed area 56, and openings 58, 60 are aligned with openings 68, 70 of liner 54. Fasteners 62, 64 are used to connect scale 52 to liner 54 and spacer 20 in the manner described above.

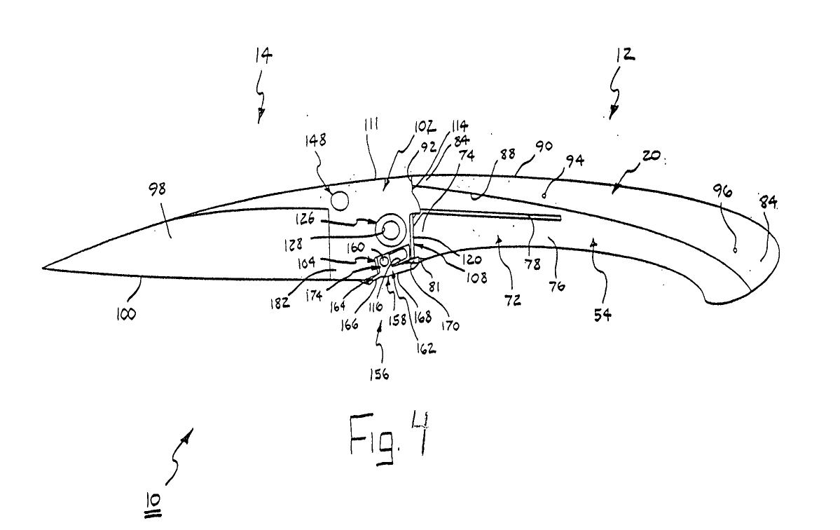

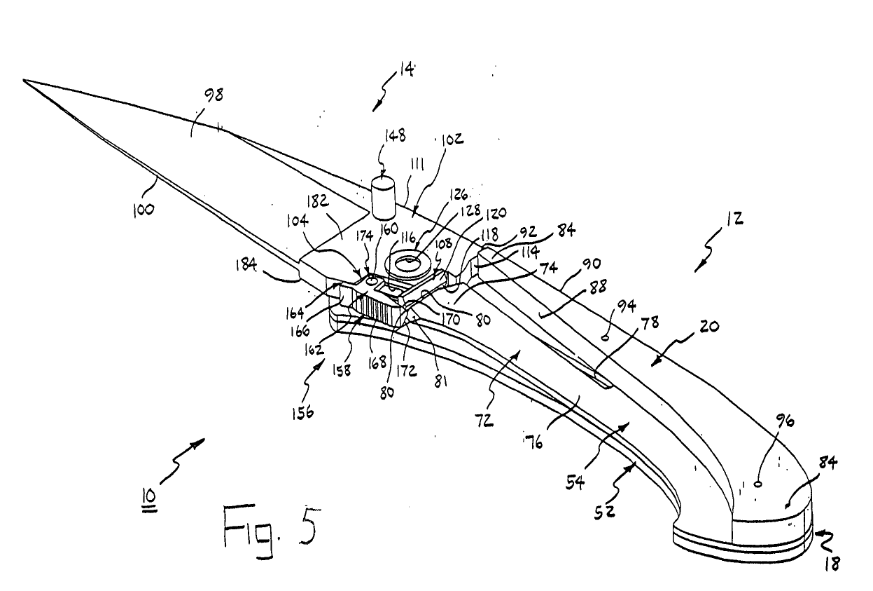

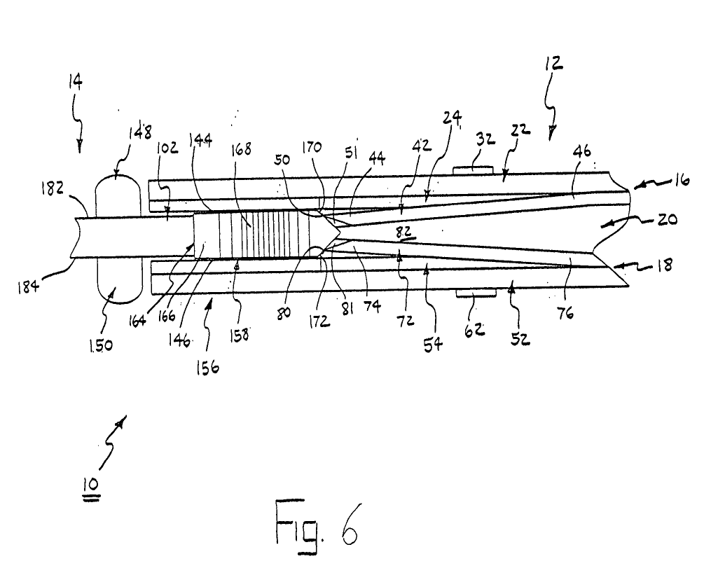

FIGS. 4-6 show knife 10 locked in an opened position. For clarity, scale 22, liner 24, pivot rod 130, and spacer 144 are not shown in FIGS. 4 and 5. When blade 14 is in the opened position, moveable arms 42, 72 extend into cavity 82 (FIG. 6) such that free ends 44, 74 are in their substantially relaxed position. As best shown in FIG. 5 and 6, when in this position, engagement surfaces 50, 80 of free ends 44, 74, contact stop surfaces 120, 118 of wedge 108, respectively. As best shown in FIG. 5, blade 14 is thereby locked in the opened position and prevented from pivoting counter-clockwise (as viewed in the figures). It should be noted that further clockwise rotation of blade 14 is also prevented by engagement between abutment surface 92 of spacer 20 and abutment surface 114 of base 102. When in this opened, in-use position, blade 14 is securely locked by both inwardly biased moveable arms 42, 72, thereby preventing accidental closure of blade 14 into body 12.

As is also shown in FIGS. 4 and 5, when blade 14 is in the opened position, actuator 158 of release mechanism 156 is positioned away from arms 42, 72. More specifically, rod 160 is positioned within slot 116 adjacent the end of slot 116 opposite wedge 108.

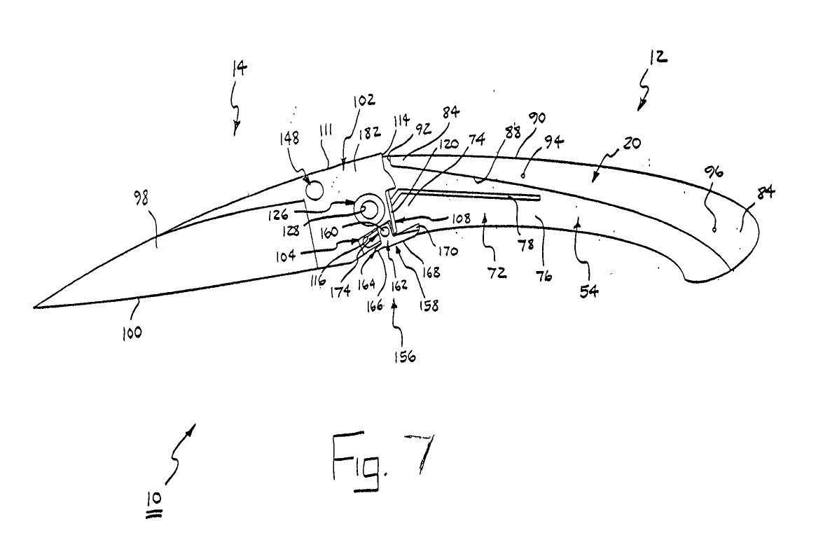

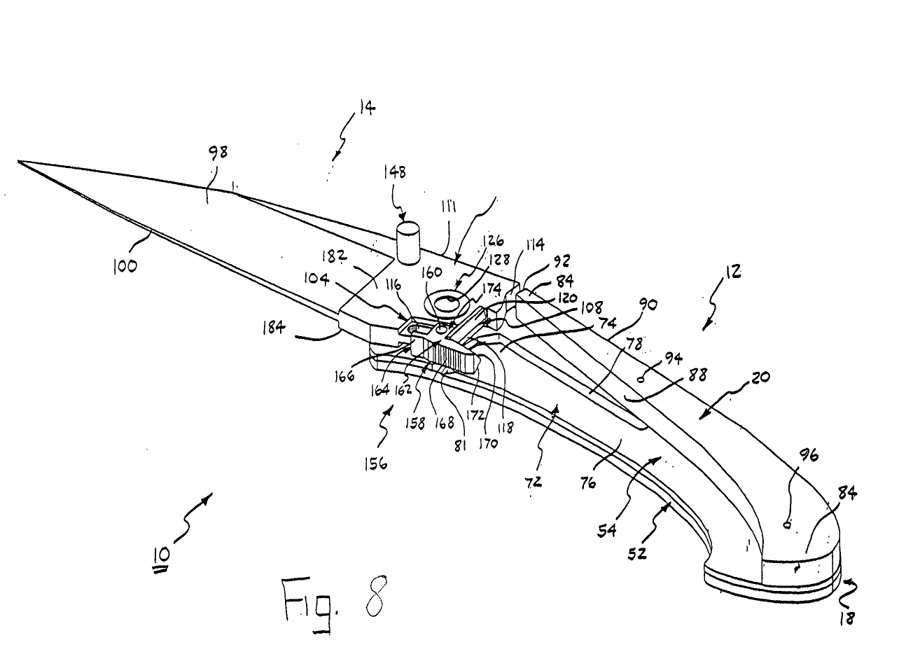

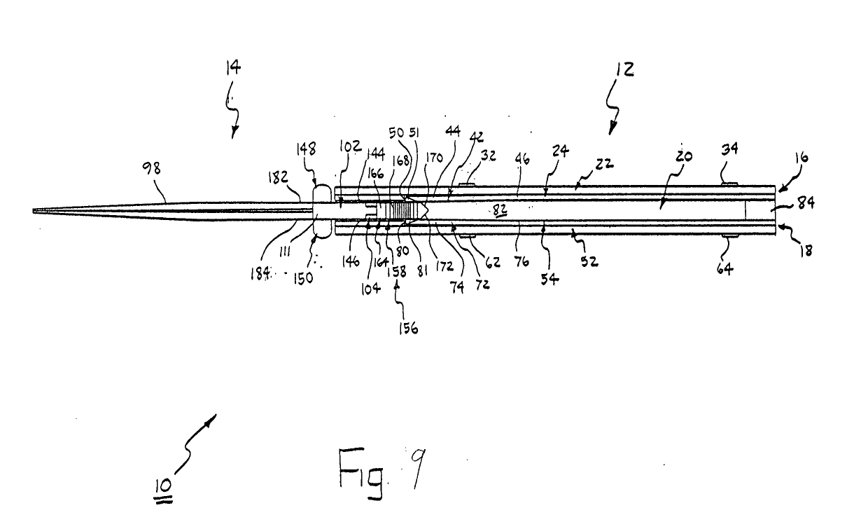

Blade 14 may be moved out of the locked, opened position by first moving release mechanism 156 toward arms 42, 72 as shown in FIGS. 7-9. More specifically, pressure is applied to bearing surface 168 of actuator 158 to move actuator 158 toward arms 42, 72 through the path of travel defined by slot 116. As actuator 158 is moved through its path of travel, rod 160 slides through slot 116 toward the end of slot 116 adjacent wedge 108. As best shown in FIG. 8 and 9, as actuator 158 is moved toward arms 42, 72, cam surfaces 170,172 bear against cam surfaces 51, 81 of free ends 44, 74. As actuator 158 is further moved in this direction, cam surfaces 170, 172 wedge between and spread apart free ends 44, 74 against the inward biasing force of arms 42, 72. When actuator 158 reaches the end of its path of travel, free ends 44, 74 are substantially flexed out of their relaxed position by an amount sufficient to permit wedge 108 (and the remainder of base 102) to slide between arms 42, 72. As best shown in FIG. 9, when fully urged away from one another by actuator 158, free ends 44, 74 are substantially planar with liners 24, 74, respectively, and are separated by a distance that is substantially equal to the thickness of base 102 of blade 14. Since free ends 44, 74 are no longer in locking engagement with stop surfaces 120, 118, blade 14 may be pivoted counter-clockwise (as viewed in the figures) out of the opened position by applying pressure to edge 111 of blade 14.

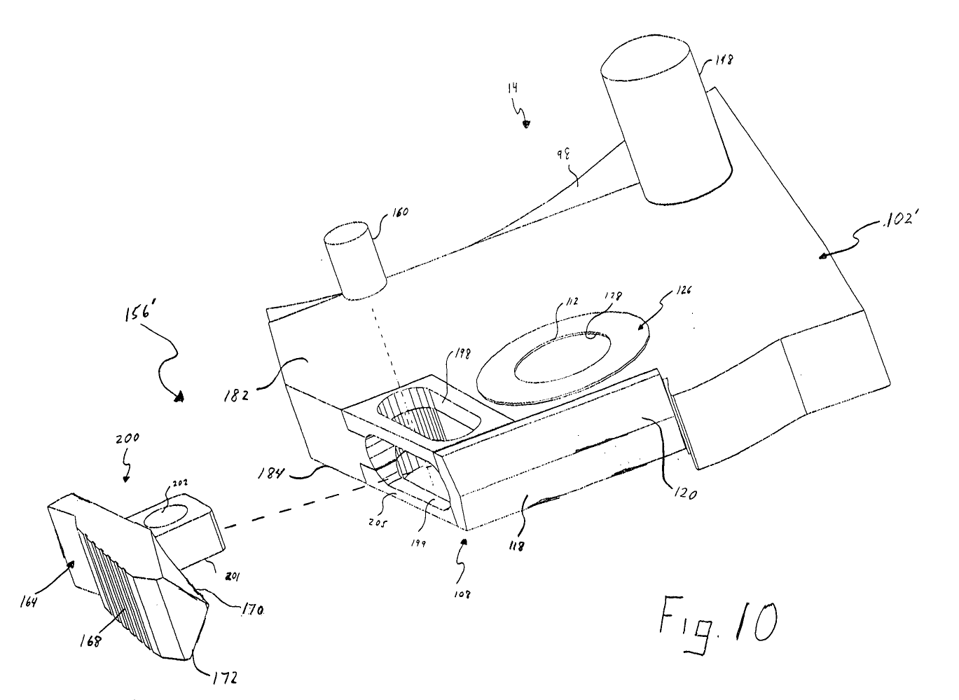

Referring to FIG. 10, an alternative embodiment of release mechanism 156′ and base 102′ is shown that is substantially similar to the embodiment disclosed in FIG. 3, except as described below. In the alternative embodiment shown in FIG. 10, base 102′ includes slot 198 and slot 199. Slot 198 extends perpendicularly through base 102′ from side 182 to side 184. Slot 199 in bottom surface 205 extends upwardly through base 102′ and intersects with slot 198. Release mechanism 156′ includes rod 160 and an actuator 200, which includes a tab 201 having an opening 202 extending therethrough. Actuator 200 includes only a single tab (201) rather than the parallel tabs (174, 176) included on release mechanism 156 of FIG. 3. Otherwise, the two release mechanisms are identical. The width of tab 201 is slightly less that the width of slot 199 to enable actuator 200 to slide within slot 198. Tab 201 of release mechanism 200 is inserted into slot 199 so that opening 202 is aligned with slot 198. Actuator 200 is coupled to base 102′ by inserting rod 160 through slot 198 and opening 202 in tab 201. Rod 160 may be press fit into opening 202 or otherwise attached by any other suitable means of coupling rod 160 in opening 202. Rod 160 is sized such that it has an outer diameter that is slightly smaller than the width of slot 198, such that rod 160 is movable along the length of slot 198. The path of travel of actuator 200 is substantially defined by slots 198 and slot 199. The length of slot 199 is substantially equal to the length of slot 198 and therefore defines the length of travel of actuator 200 when positioned within slot 199. It should be noted that recessed portion 104, shown in FIG. 3, is not present in the alternative embodiment.

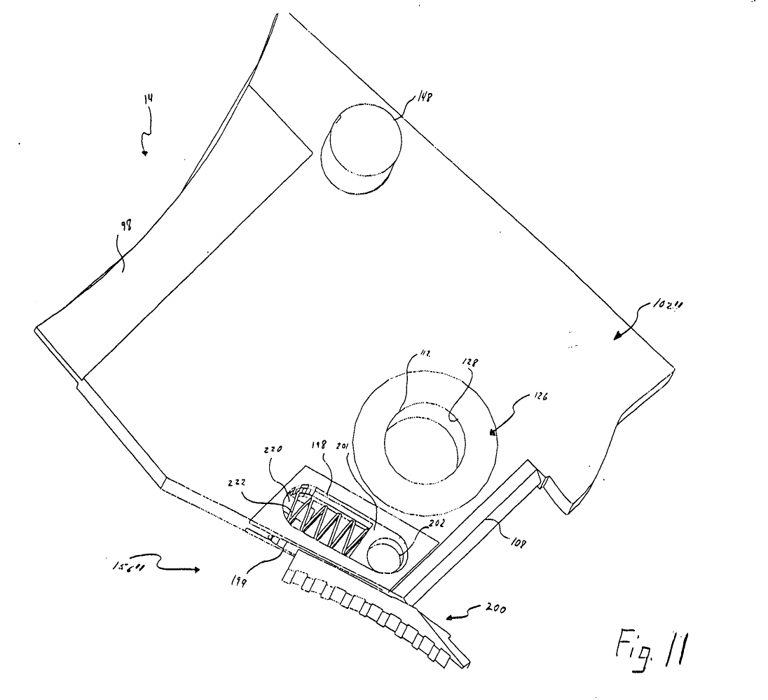

Referring now to FIG. 11, yet another embodiment of a release mechanism 156″ and a base 102″ is shown that is substantially similar to the embodiment disclosed in FIG. 3, except as described below. In this embodiment, a post 220 and a spring 222 have been added to base 102″. Post 220 is mounted in the end of slot 198 adjacent blade 14. Post 220 can be affixed in this position by welding, milling, brazing, adhesives, or any other suitable method. Spring 222 is positioned over post 220 on one end and abuts tab 201 of actuator 200 on the opposing end. Rod 160 (not shown) is positioned through slot 198 of base 102″ and opening 202 of tab 201 to retain actuator 200 in slots 198 and 199. Spring 222 biases actuator 200 in the opposite direction of blade 14. To close knife 10, a user must slide actuator 200 up or toward blade 14, then down or toward the handle portion of knife 10 to engage arms 42, and 72 as previously described.

The use of spring 222 and post 220 are not limited to the embodiment shown in FIG. 11, but can be incorporated into any suitable base or equivalent disclosed herein. For example, spring 222 and post 220 can also be used with actuator 158 of release mechanism 156 shown in FIG. 3. It should be noted that actuator 158 includes parallel tabs 174, 176 while actuator 200 of FIG. 11 includes a single tab 201. Referring generally to FIG. 3, post 220 could be affixed in the end of slot 116 adjacent blade 14 and spring 222 could be positioned over post 220 on one end and abut rod 160 on the opposing end to bias actuator 158 toward the handle portion of the knife.

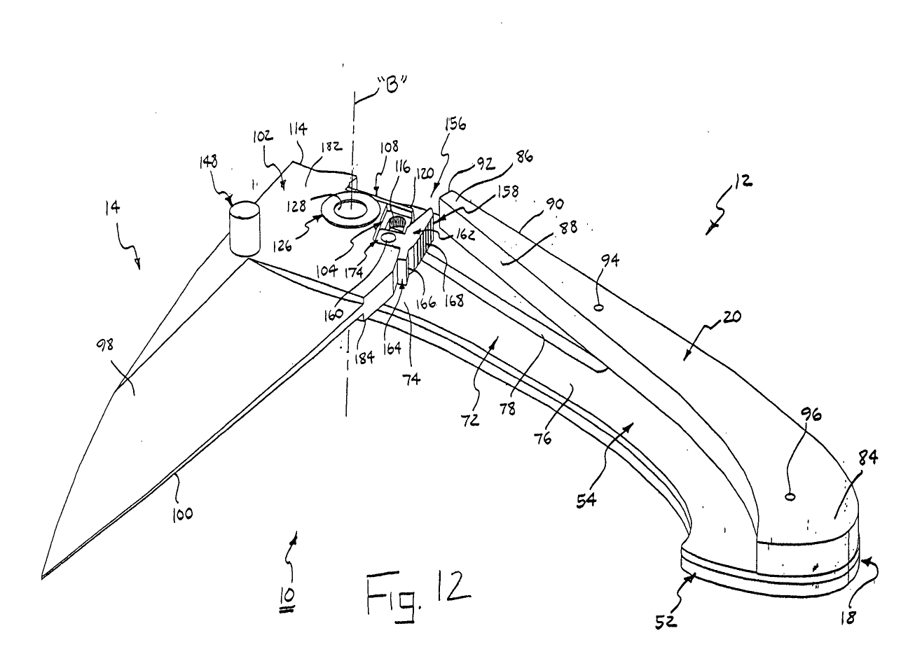

FIG. 12 shows blade 14 approximately halfway through its rotation about rotation axis “B” between the opened position and the closed position. As blade 14 rotates, ends 44, 74 of arms 42, 72 are urged against and ride along side surfaces 182, 184, respectively, of blade base 102. Since arms 42, 72 are flexed out of their relaxed position, the biasing force generated by the resiliency of arms 42, 72 urges the arms against side surfaces 182, 184, thereby providing some resistance to the rotation of blade 14.

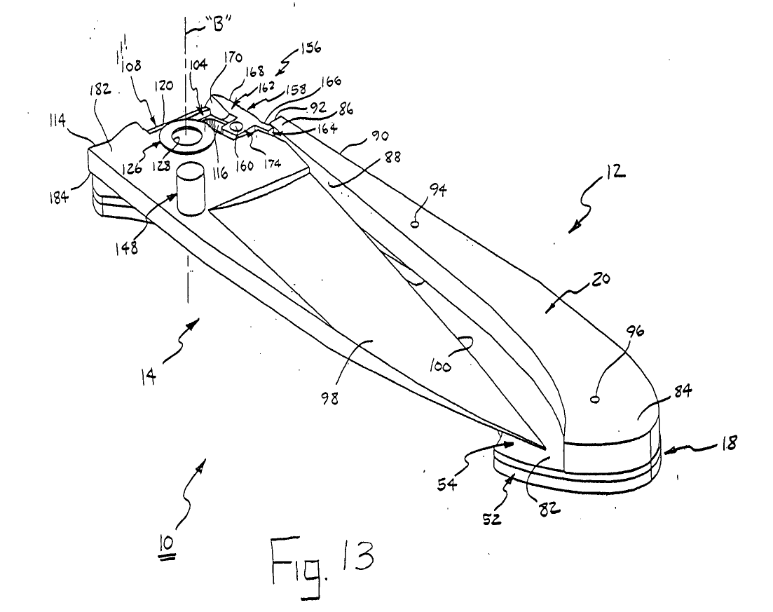

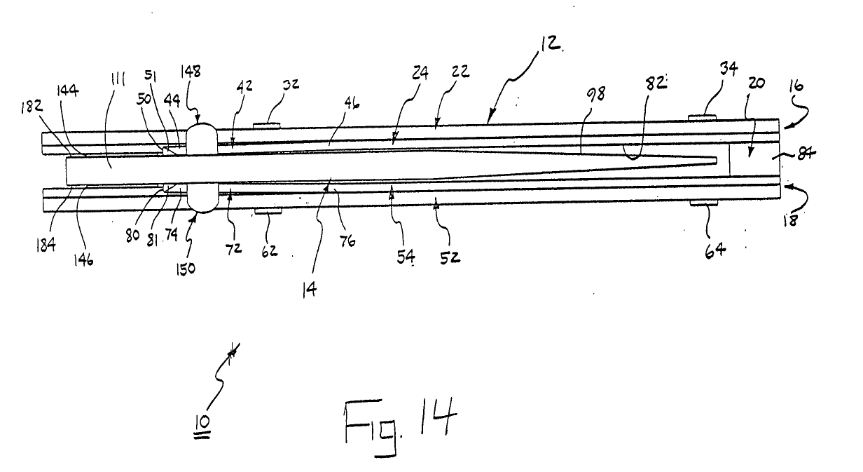

FIGS. 13 and 14 show knife 10 in its closed position. As best shown in FIG. 13, a substantial portion of blade 14, including sharpened edge 100 is disposed within cavity 82. When blade 14 reaches the closed position, stop surface 166 of end tab 164 engages side 88 of spacer 20 at end 86. This engagement prevents further rotation of blade 14 about axis “B,” and prevents sharpened edge 100 of blade 14 from engaging side 88 of spacer 20. As shown in FIG. 14, free ends 44, 74 of arms 42, 72 remain biased against side surfaces 182, 184, respectively. The compressive force supplied by ends 44, 74 retains blade 14 in the closed position. This compressive force, however, can be overcome by pushing against either thumb stud 148 or thumb stud 150.

While holding body 12 with the palm and fingers of one hand, the thumb of that hand is free to urge the appropriate thumb stud 148, 150 upwardly causing rotation of blade 14 out of the closed position. In this manner, blade 14 may be rotated clockwise (as viewed in the figures) to the opened position as shown in FIG. 1. When blade 14 reaches the opened position, ends 44, 74 of arms 42, 72, snap inwardly toward one another to engage stop surfaces 120, 118, respectively, thereby locking blade 14 in the opened position as described above.

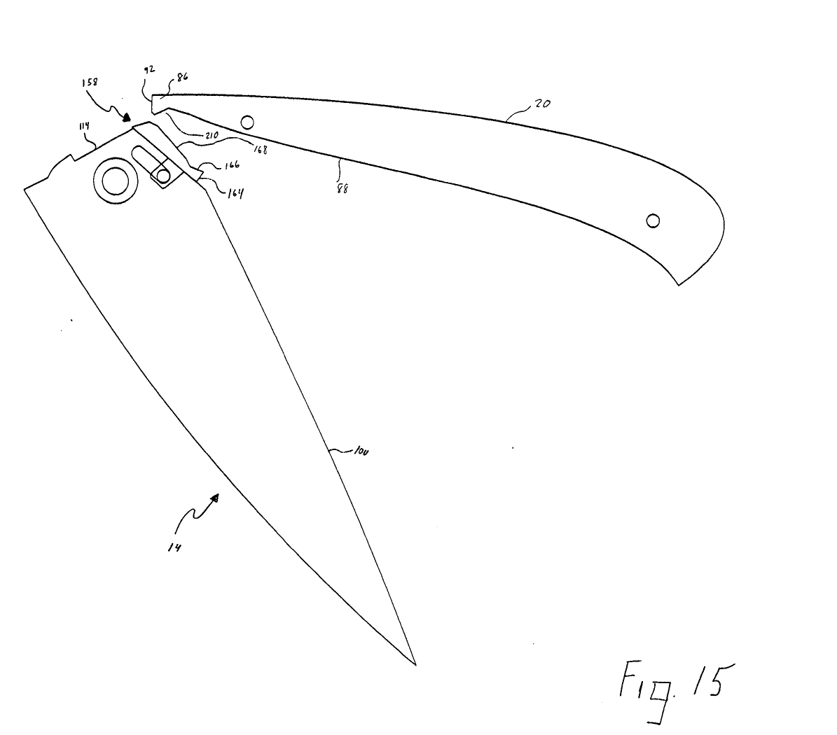

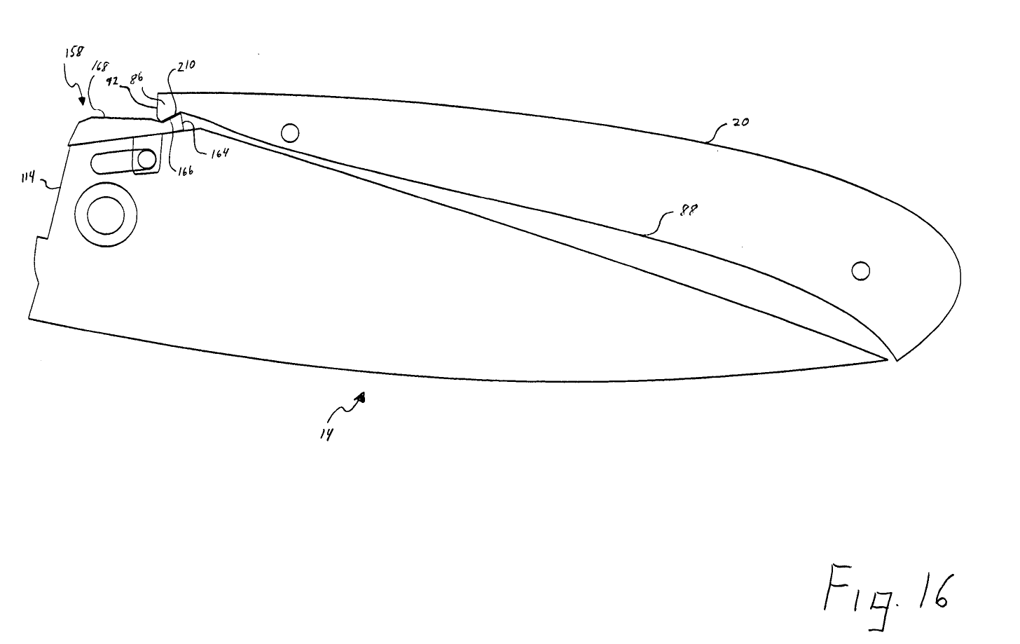

Referring to FIG. 15 and 16, an alternative embodiment of spacer 20 is shown that is substantially similar to the embodiment of FIGS. 12 and 13, except as described below. In this embodiment, end 86 of spacer 20 includes a notch 210. Notch 210 corresponds to an angle formed between stop surface 166 and bearing surface 168 of actuator 158. As shown in FIG. 16, when blade 14 reaches the closed position, stop surface 166 engages notch 210 to prevent movement of blade 14 when in the closed position. This engagement also prevents sliding movement of actuator 158 while knife 10 is in the closed position. The addition of notch 210 to spacer 20 is not intended to be limited to the embodiment shown in FIGS. 15 and 16, and can be incorporated into any suitable spacer or equivalent structure.

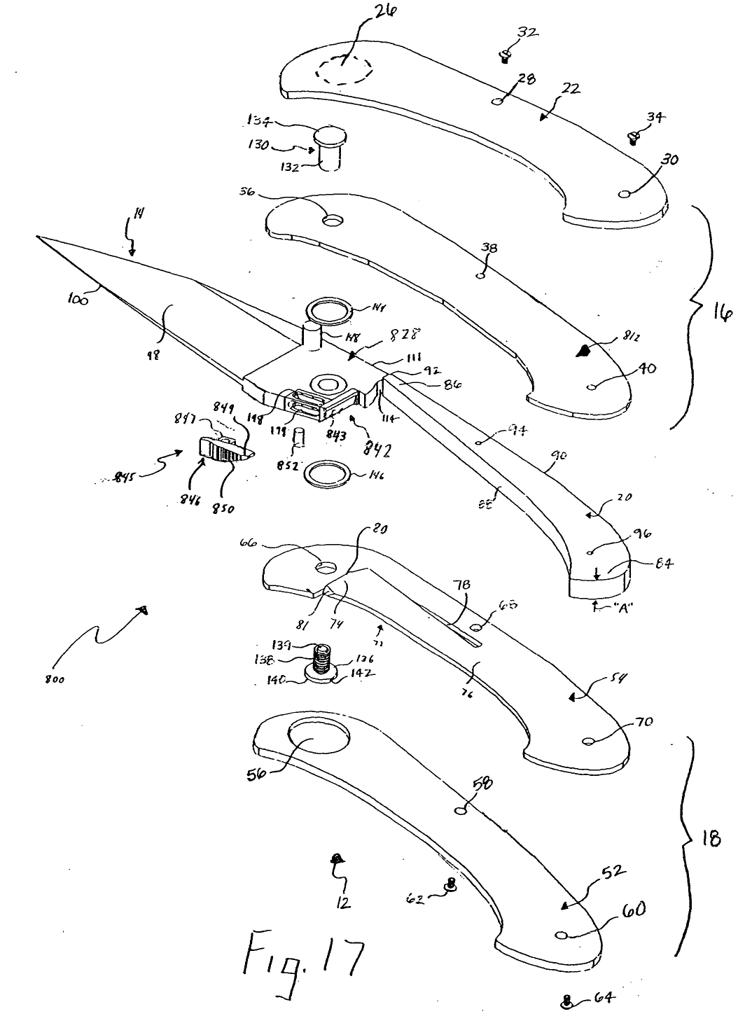

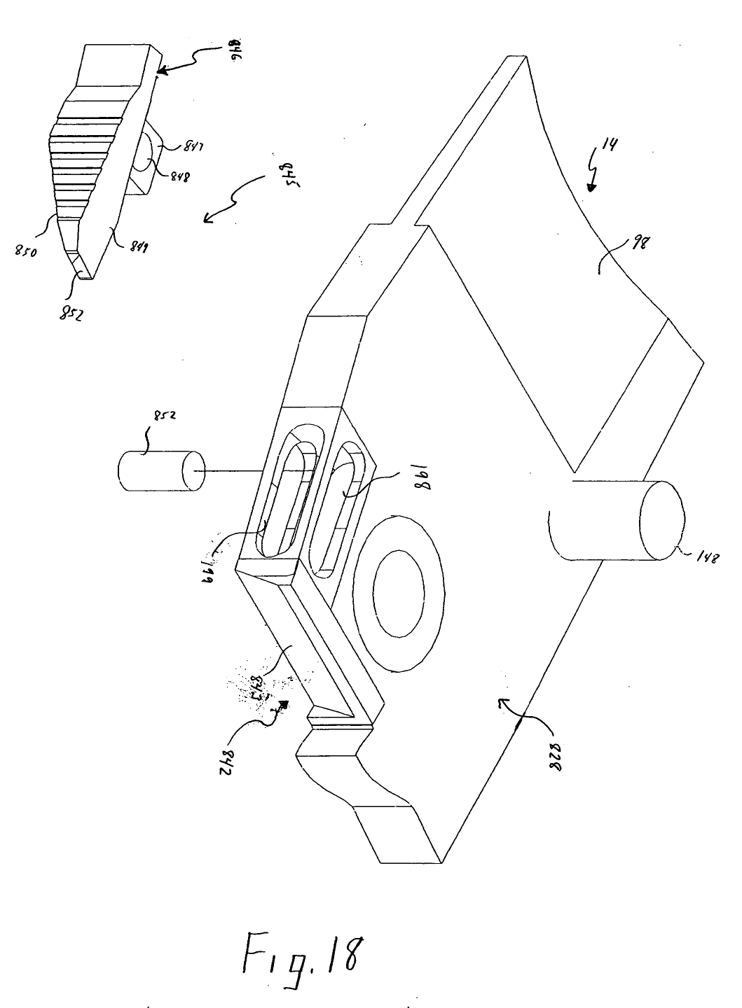

An alternative embodiment of the knife 10 of FIG. 2 is shown in FIGS. 17-20. Referring to FIG. 17, knife 800 is substantially similar to knife 10 of FIG. 2, except as described below. Knife 800 includes only a single moveable arm 72 rather than the two moveable arms 42, 72 shown in FIG. 2. Liner 812 of knife 800 is substantially flat and does not include a moveable arm. Liner 54 is identical to liner 54 shown in FIG. 2 and includes arm 72 which is bent or biased inward. Base 828 is similar to base 102′ of FIG. 10, except that wedge 842 includes only one stop surface 843 whereas wedge 108 of FIG. 10 includes two stop surfaces 118, 120. Release mechanism 845 is similar to release mechanism 156′ of FIG. 10, but actuator 846 includes only one cam surface 850 whereas actuator 156′ includes two cam surfaces 170, 172. More specifically, release mechanism 845 includes actuator 846 and rod 852. Actuator 846 of knife 800 utilizes the single tab design shown in FIG. 10, but the dual tab design shown in FIG. 2 could also be used in the present embodiment. As best shown in FIG. 18, actuator 846 includes a tab 847 having an opening 848. To attach actuator 846 to base 828, tab 847 is inserted into slot 199 of base 828 and rod 852 is secured in slot 198 and opening 848 of tab 847. Actuator 846 includes a flat side 849 which is positioned adjacent liner 812 and a cam surface 850 which is positioned adjacent arm 72 of liner 54.

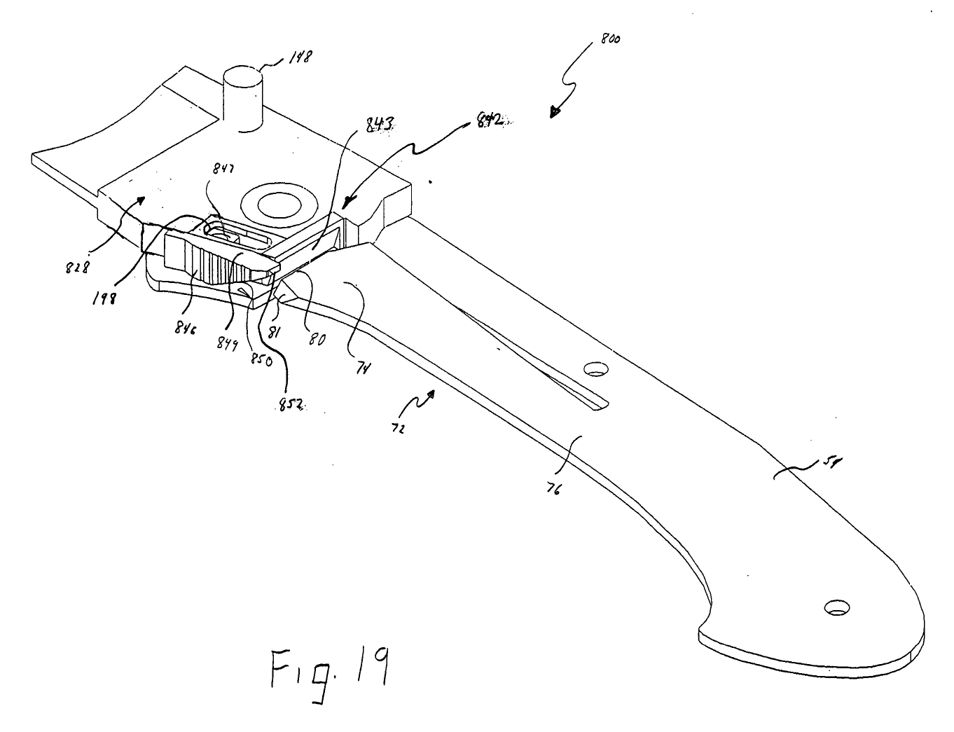

As best shown in FIG. 19, stop surface 843 of wedge 842 is positioned adjacent end 74 of arm 72 when knife 800 is opened. When knife 800 is opened and actuator 846 is not engaged, engagement surface 80 of arm 72 abuts stop surface 843 of base 828 to prevent knife 800 from being closed.

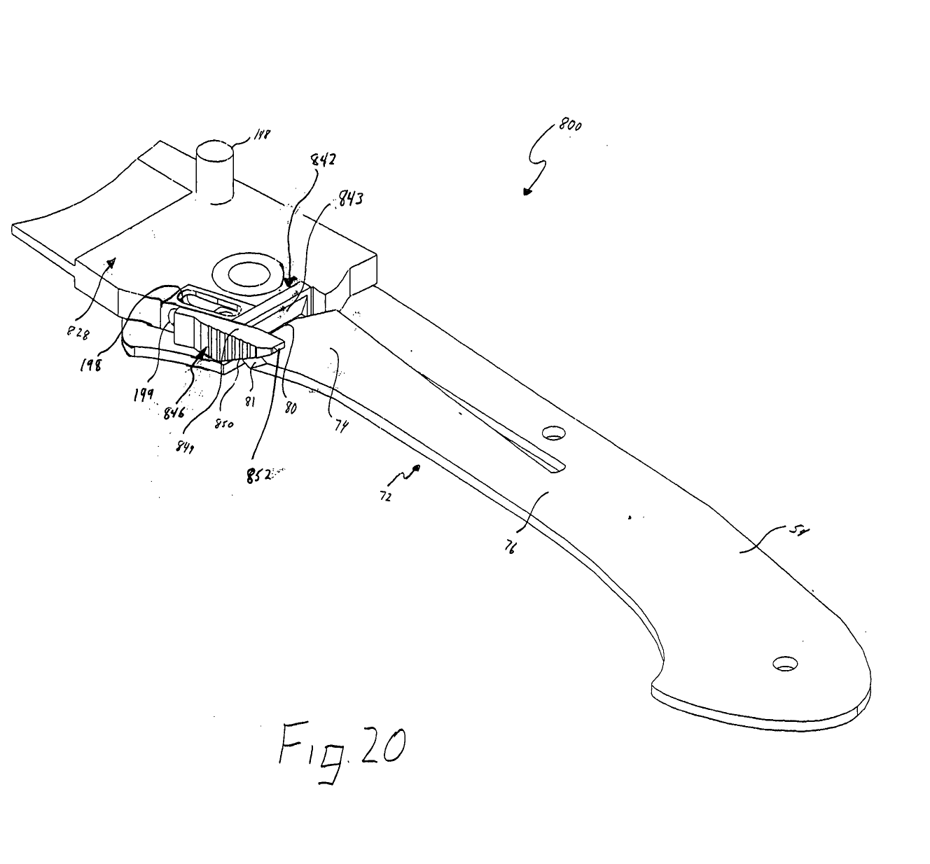

Referring now to FIG. 20, actuator 846 is shown in the engaged position. The user moves actuator 846 from the position shown in FIG. 19 to the engaged position of FIG. 20 by sliding actuator 846 toward arm 72 with the thumb in the same manner as that described above. As actuator 846 is moved toward arm 72, end 852 of actuator 846 slides past engagement surface 80 of arm 72. As end 852 slides past engagement surface 80, cam surface 850 of actuator 846 contacts cam surface 81 and pushes arm 72 outwardly such that engagement surface 80 moves clear of stop surface 843 of wedge 842, thereby allowing base 828 to begin to rotate to close knife 800. It should be noted that actuator 846 must be moved toward arm 72 with sufficient force to overcome the inward bias of arm 72.

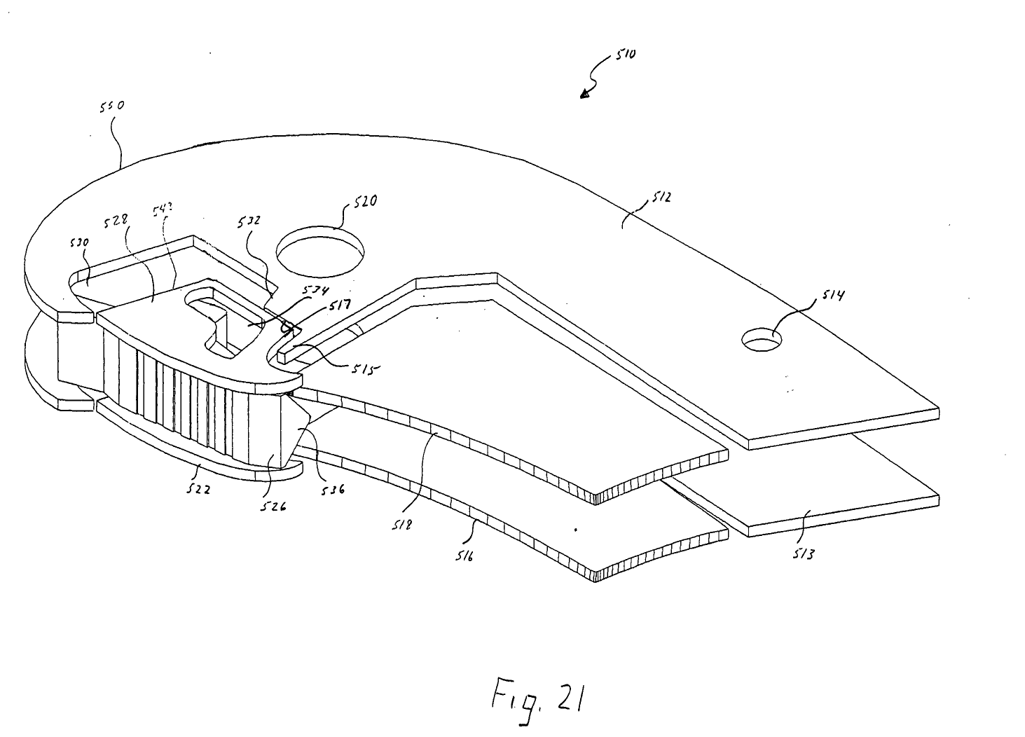

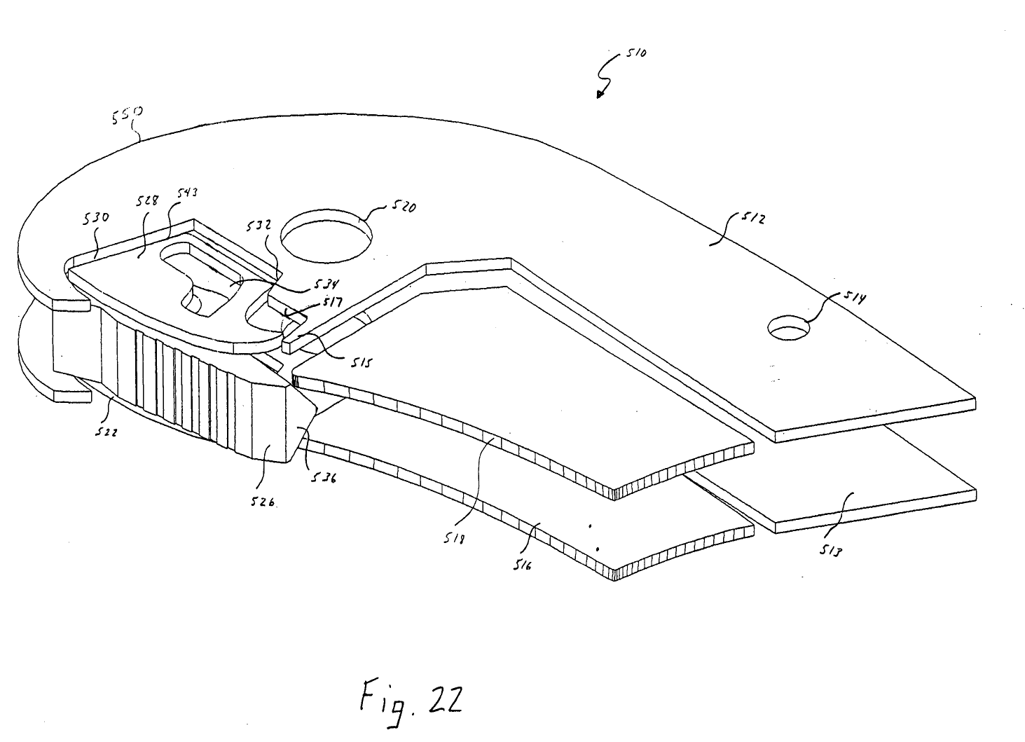

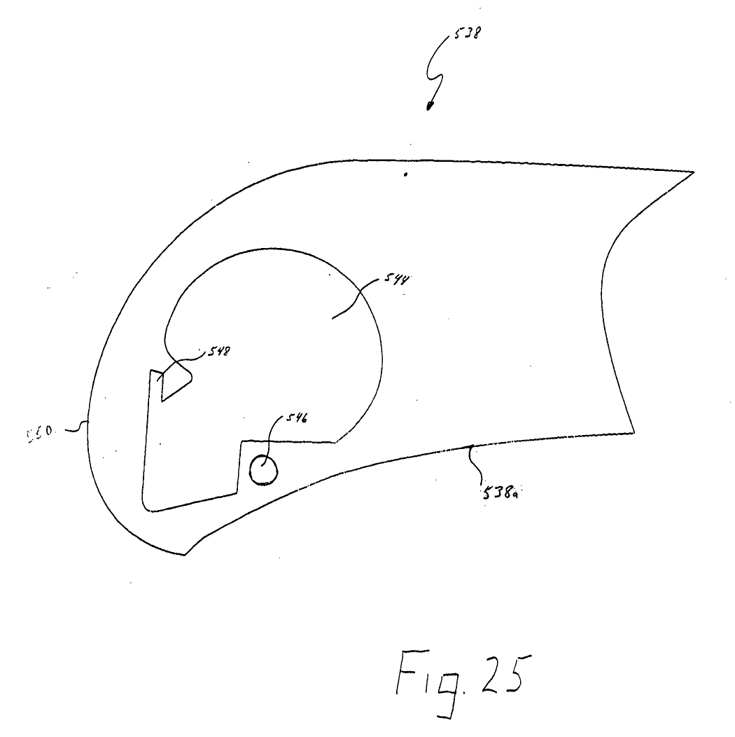

An alternative embodiment of knife 10, of FIG. 2 is shown in FIGS. 21-29. Referring to FIGS. 21 and 22, knife 510 is substantially similar to the embodiment shown in FIG. 2, except as described below. Knife 510 includes spacer 20, blade 14, scales 22, 52, all of FIG. 2, which have been removed for clarity. Knife 510 also includes modified liners 512, 513 which respectively include openings 530, 531 (only one shown). Openings 530, 531 are shaped to accept safety members 528, 522, as further described below. Liners 512, 513 also include moveable arms 516 and 518 which operate in the same manner as arms 42, 72 as shown in FIG. 2.

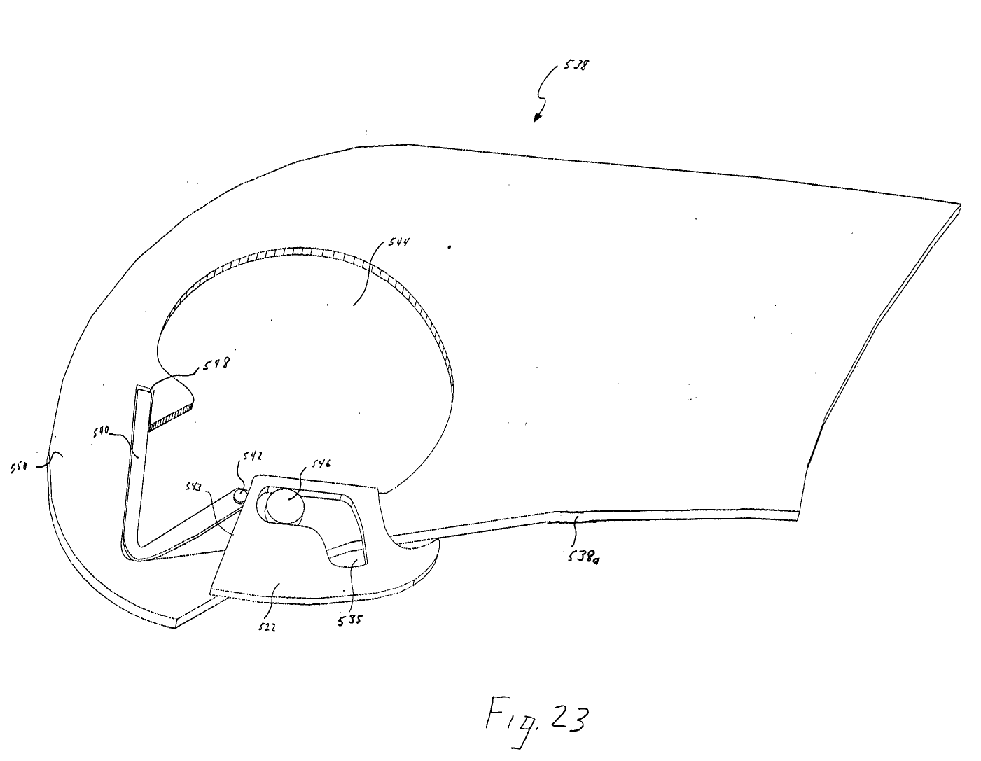

Knife 510 further includes an actuator 526 which is positioned between a pair of safety members 522, 528 and is configured to separate arms 516, 518 when actuator 526 is depressed and moved toward arms 516, 518 in the manner described above with respect to the other release mechanism embodiments. The top surface of actuator 526 is recessed below the top edges of safety members 522, 528 to limit access to actuator 526. Safety members 522, 528 are positioned on each side of actuator 526 within openings 530, 531, respectively, and are approximately the same thickness as liners 512, 513. Safety members 522, 528 include channels 534, 535 (FIGS. 23, 24, 27, and 29). A scale 539 (not shown) attaches to liner 512 and captures cover 528 within opening 530 as further described below. Another scale 538 (FIGS. 23-27) similarly attaches to liner 513 and captures cover 522 within opening 531 (not shown). It should be noted that liners 512, 513 are basically mirror images of one another. Liners 512, 513 include a plurality of openings (only opening 514 is shown) that allow fasteners to pass through to attach to scales 538, 539 to spacer 20 (FIG. 2) in the manner described above.

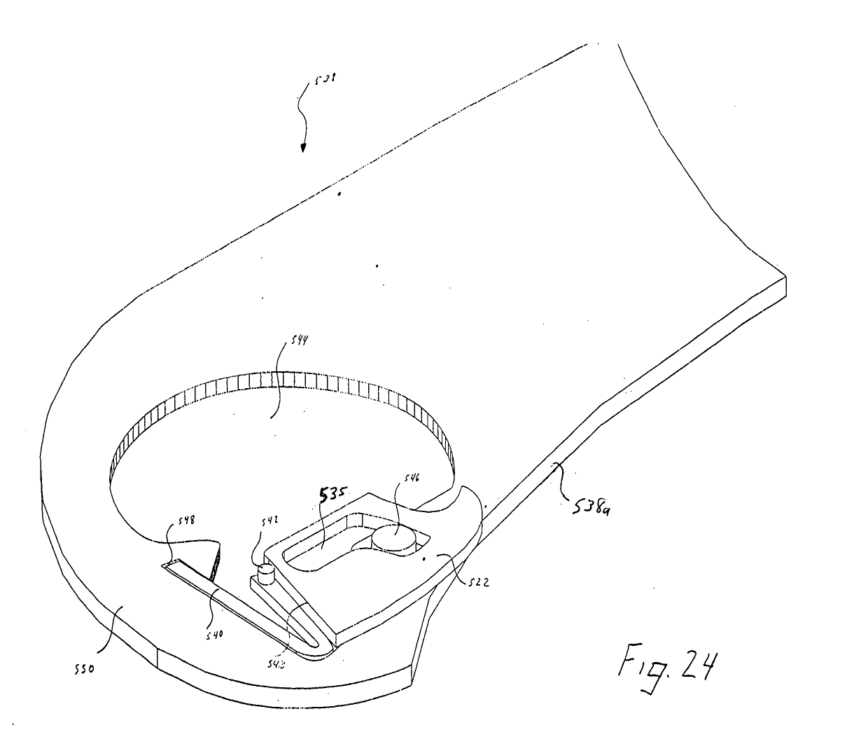

Referring now to FIGS. 23-25, scale 538 is similar to scale 52 shown in FIG. 2 with the exception of a post 546 and a recess 544. As would be known by one of ordinary skill in the art, there are a variety of suitable methods of affixing post 546 to scale 538 such as forming, milling, or welding the post onto scale 538, or inserting the post through an opening in scale 538. When knife 510 is assembled, post 546 on scale 538 is positioned in channel 534 of safety member 528. Recess 544 is included in scale 538 to allow clearance for pivot pin 130 (FIG. 2). Recess 544 includes a notch 548 to secure a spring 540 in recess 544. One end of spring 540 is positioned in notch 548 while the other end of spring 540 (which includes a post 542) is positioned adjacent side 543 of safety member 522. Post 546 extends from spring 540 and contacts side 543 of safety member 522 to apply a biasing force to safety member 522 toward the handle portion of knife 510. The shape of channel 535 in safety member 522 defines the path of travel of safety member 522 on post 546. In this embodiment, channel 535 is shaped to allow safety member 522 to move downward relative to edge 538a of scale 538 as it is pushed toward end 550 of scale 538. As shown in FIG. 24, when safety member 522 is pushed toward end 550 with sufficient force to overcome the force of spring 540, safety member 522 slides along post 546 on the path defined by channel 535. It should be noted that scale 539 (not shown) which would be adjacent to liner 512 is a mirror image of scale 538 and includes a similar recess, notch, post, and spring configured to interact with safety member 528 in the same manner as scale 538, recess 544, notch 548, post 546, and spring 540 interact with safety member 522.

Referring to FIGS. 21, 22, 27, and 28, when safety members 522, 528 are depressed, springs 540 are compressed and safety members 522, 528 slide toward end 550 and downward behind notches 532, 533 (only notch 532 is shown), uncovering actuator 526. With the top edges of safety member 522, 528 now below the top surface of actuator 526, the user can actuate actuator 526 to close knife 510 in the manner described above.

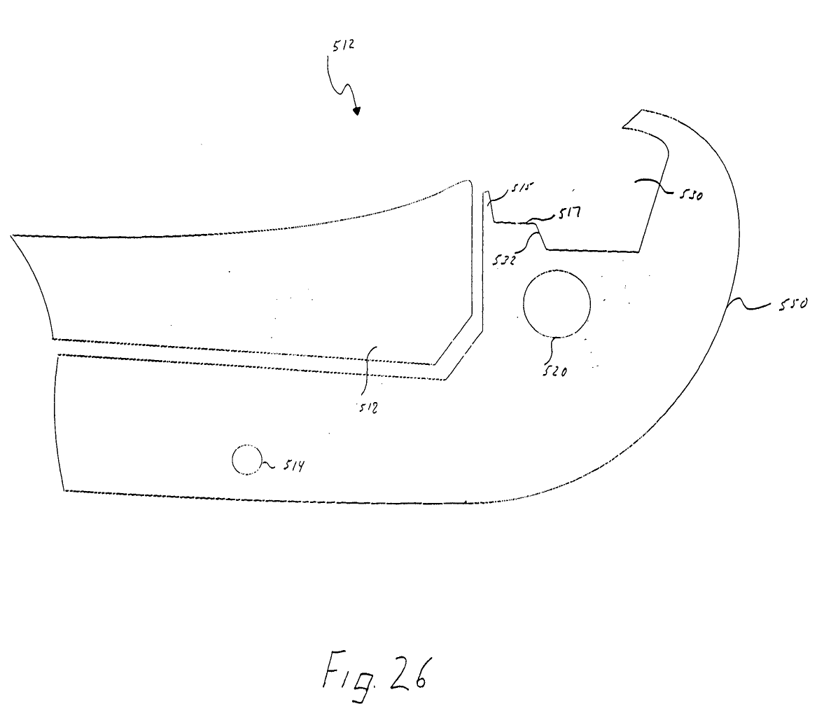

Referring to FIG. 26, liner 512 is shown with openings 514, 520, arm 518, and opening 530. Opening 514 allows a fastener inserted in the scale to couple to spacer 20 as described above. Opening 520 receives pivot pin 130 as described above. Opening 530 includes notch 532 and extension 515. When safety member 528 is covering actuator 526, safety member 528 abuts extension 515 and rests on the ledge 517 formed above notch 532. When safety member 528 is moved toward end 550, safety member 528 slides toward end 550 of knife 510 and downward until it is positioned adjacent notch 532 in the lowest portion of opening 530. It should be noted that liner 513 and the scale (not shown) coupled to it are mirror images of liner 512 and scale 538 and include the same features.

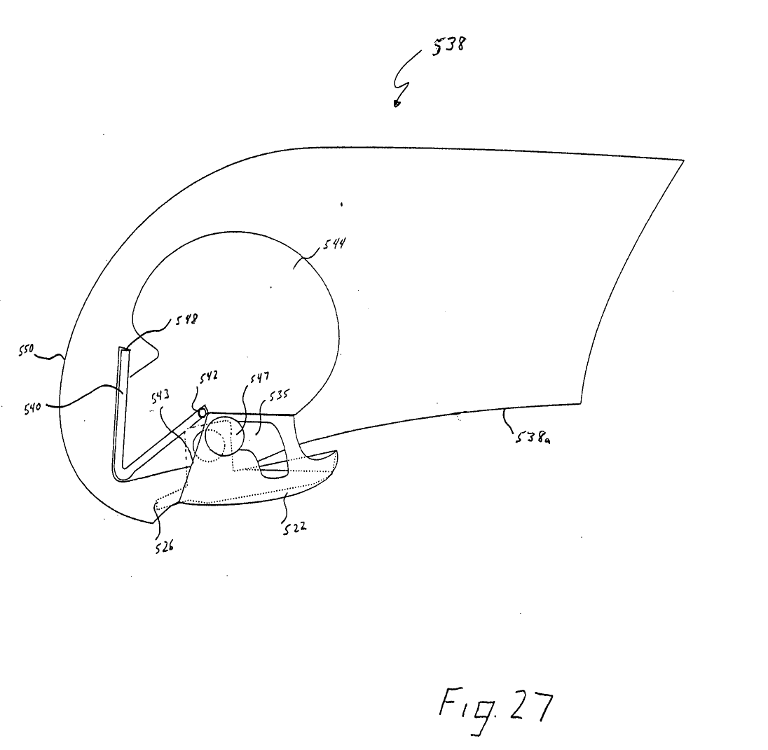

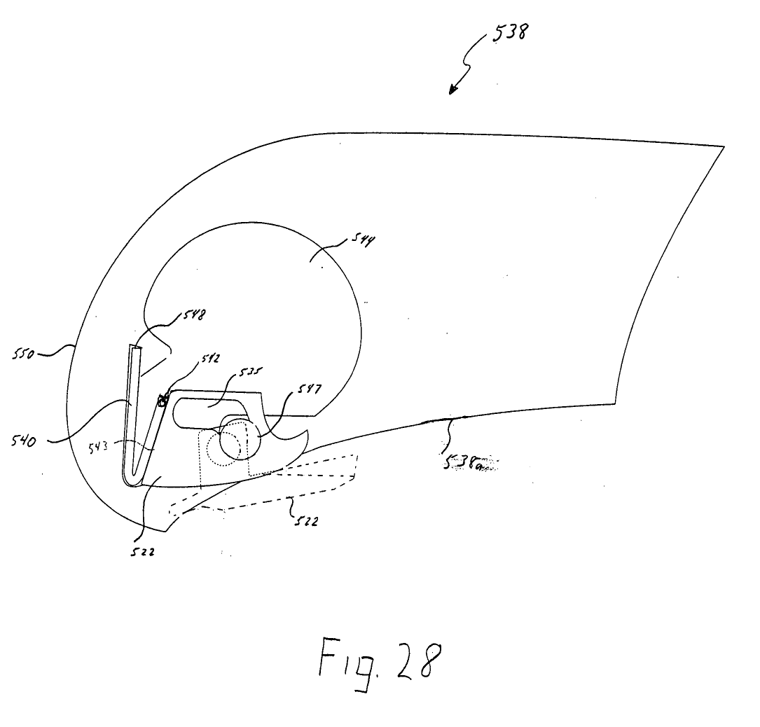

Referring to FIGS. 27 and 28, scale 538 is shown with actuator 526 (shown in dotted lines) in its default position, knife 510 opened, and safety member 522 biased forward by spring 540. For clarity, liner 513, spacer 20, liner 512, and scale 539 are not shown. When actuator cover 522 is in this default position, as shown in FIG. 27, actuator 526 is covered and cannot be easily engaged to close blade 14 of knife 510. It should be understood that safety member 528 is similarly positioned. Together, safety members 522, 528 (when in the default position) prevent accidental actuation of actuator 526, thereby avoiding possible injury associated with accidental closure of knife 510. Referring to FIG. 28, safety member 522 is shown depressed and moved back against the biasing force of spring 540 so that actuator 526 is uncovered. Safety members 522, 528 are preferably depressed by the thumb of the user and pushed toward end 550. The user can then contact actuator 526 with the thumb to close blade 14 of knife 510 in the manner described above. As previously described, safety members 522, 528 move along the path defined by channels 534, 535. The path defined by channels 534, 535 is not intended to be limited to the shape shown in this embodiment.

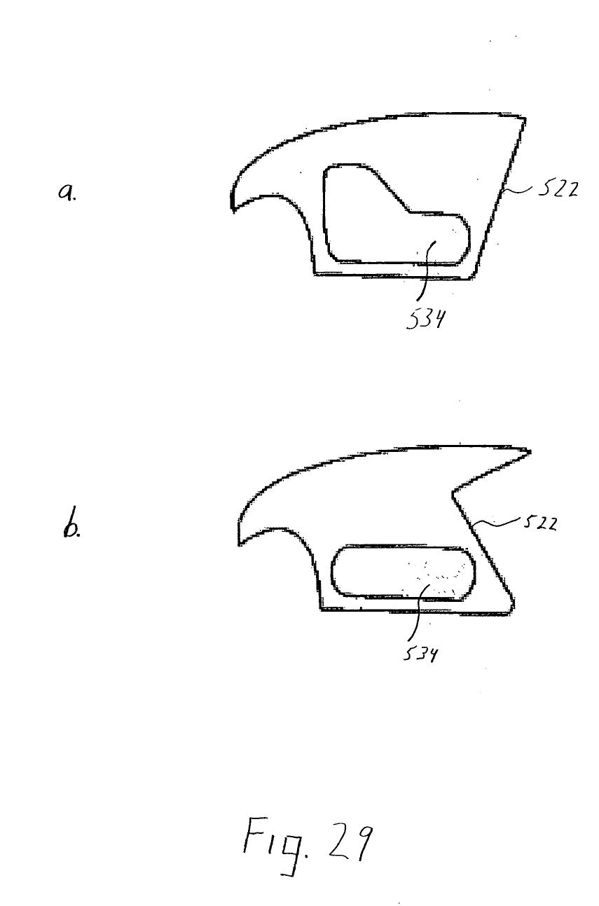

Alternative embodiments of safety member 522 are shown in FIGS. 29a and 29b. It should be understood that safety member 528 should be essentially identical to safety member 522 in each embodiment. For simplicity, only cover 522 is described. Referring to FIG. 29a, safety member 522 includes a generally triangularly shaped channel 534. In another example, referring to FIG. 29b, channel 534 of safety member 522 is substantially horizontally shaped. As previously discussed, the shape of channel 534 defines the movement of safety member 522. Channel 534 in safety member 522 may define any path that allows the user to move safety member 522 into opening 530 in liner 512, thereby exposing actuator 526 for use by the user to close knife 510.

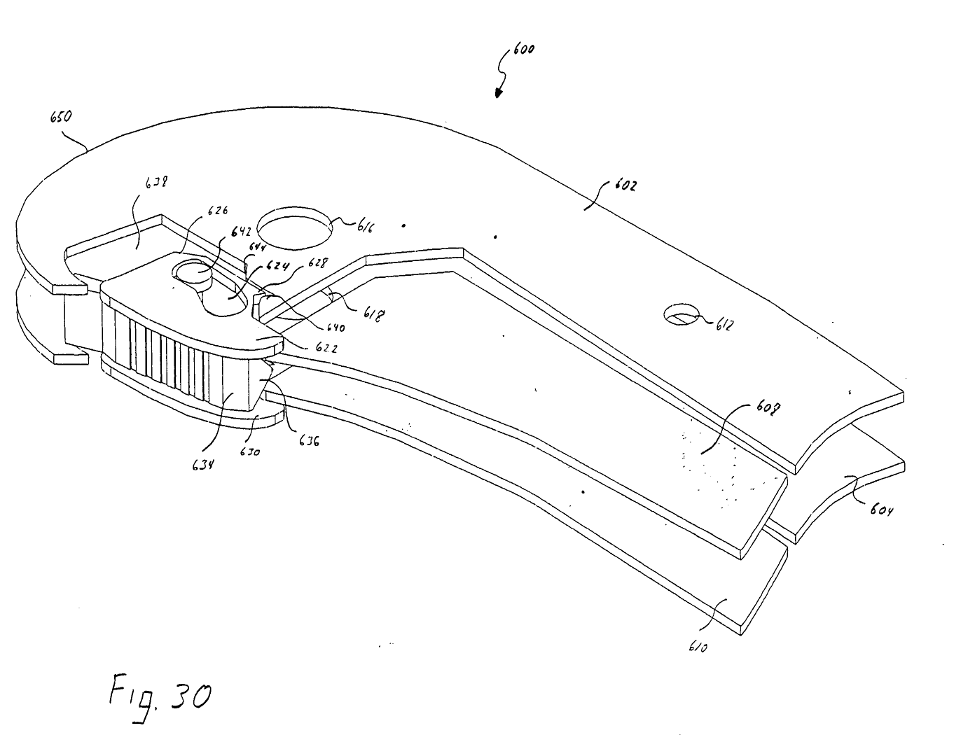

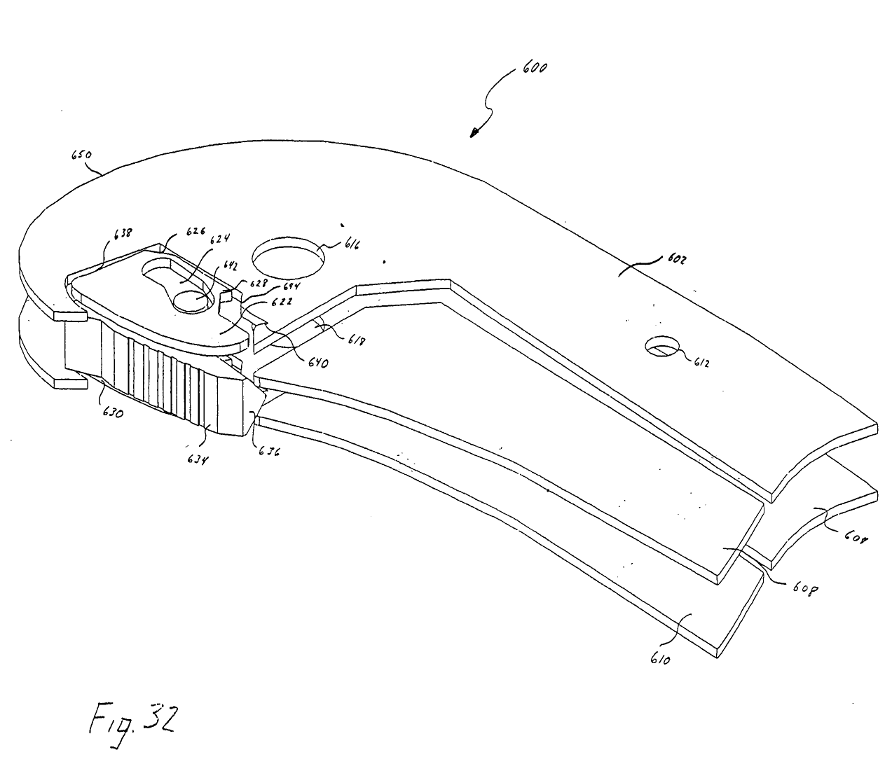

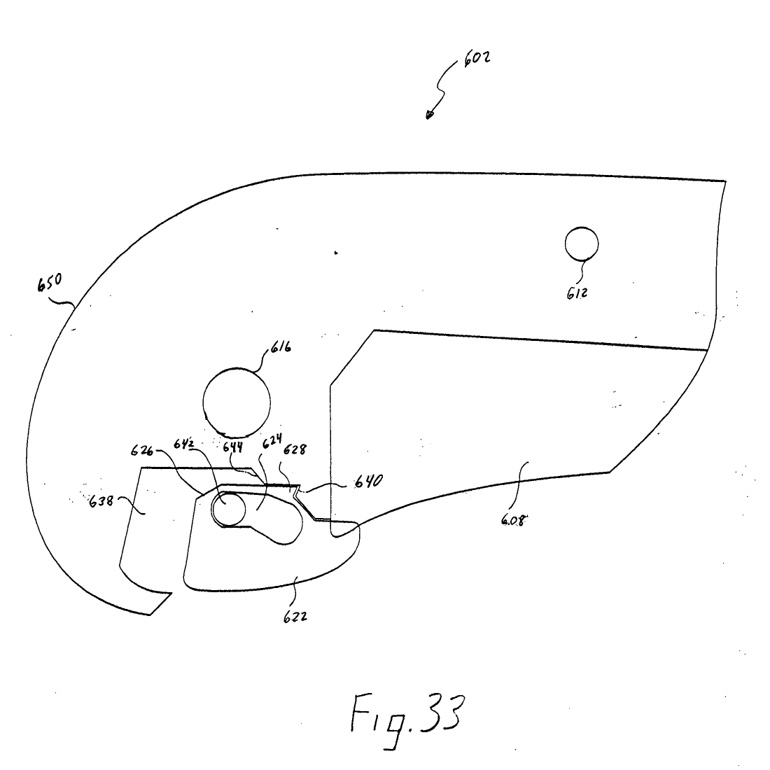

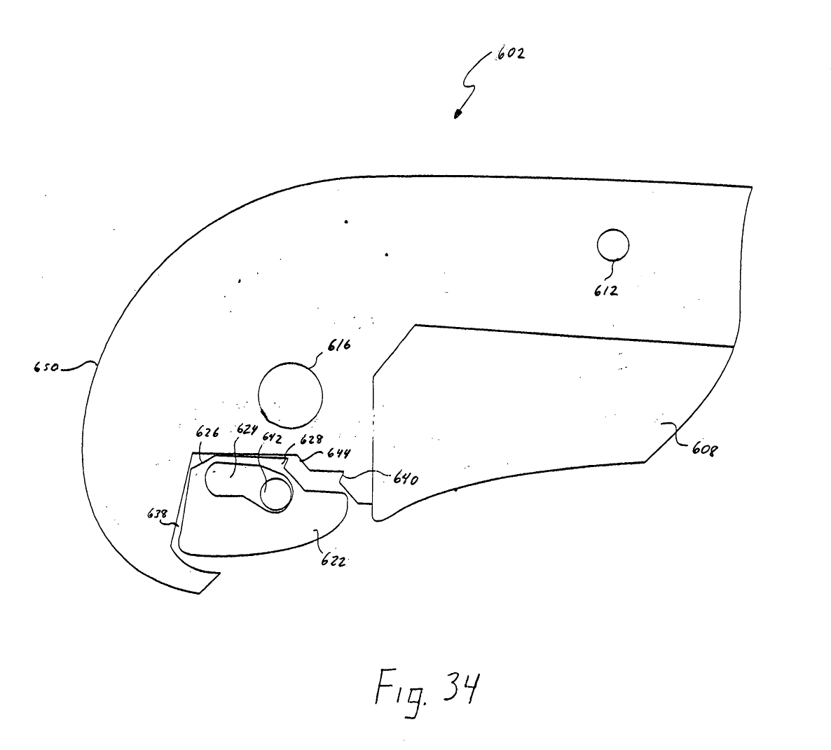

An alternative embodiment of the knife disclosed in FIGS. 21-29 is shown in FIG. 30. Knife 600 is substantially similar to knife 510 shown in FIG. 21, except as described below. Knife 600 includes liners 602, 604 which include arms 608, 610, respectively. Liners 602, 604 include openings 638, 639, respectively, (only opening 638 is shown) adjacent end 650 of knife 600. It should be noted that liners 602, 604 are basically mirror images of one another. Accordingly, only liner 602 and its associated safety member 622 are discussed below. Liner 602 differs from liner 512 (FIG. 21) in that it includes a lower notch 644 (not shown). As shown in FIGS. 32 and 34, safety member 622 is positioned behind lower notch 644 when safety member 622 is depressed to uncover actuator 634. Liner 602 also includes an upper notch 640 which corresponds in shape to end 628 of safety member 622. Safety member 622 includes channel 624, which slides along a post 642 on the attached scale (not shown) in the manner described above. Referring to FIGS. 33 and 34, safety member 622 also includes a rear notch 626 which is configured to provide clearance for a post coupled to a spring mounted in the attached scale (not shown) similar to the embodiment shown in FIG. 24.

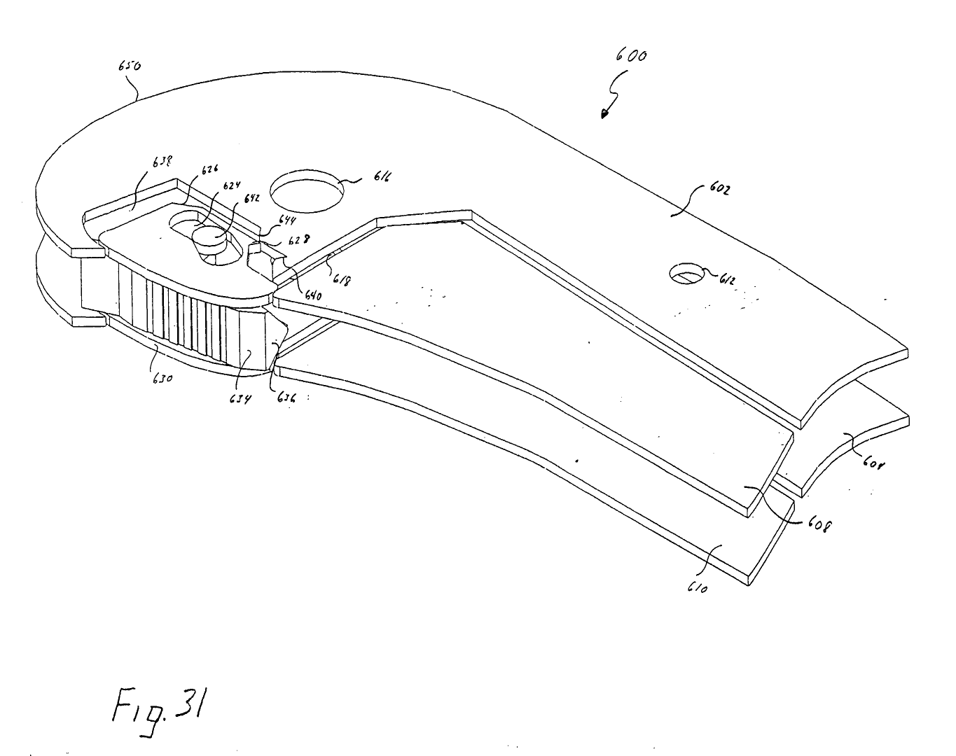

Referring to FIGS. 30 and 33, when knife 600 is opened, safety members 622, 630 are biased in the raised or forward position by springs (not shown) mounted in the attached scales (not shown). Referring only to liner 602 and safety member 622, in the raised position, end 628 fits within upper notch 640. The user must depress safety member 622, preferably with the thumb, to move it back into opening 638 in liner 602 to uncover actuator 634. As shown in FIG. 31, safety member 622 slides along post 642 on the path defined by channel 624. Referring now to FIGS. 32 and 34, safety member 622 is shown after being moved completely within opening 638, thereby uncovering actuator 634. In this position, end 628 of safety member 622 is positioned behind lower notch 644 in liner 602 as shown in FIG. 34. The user can then actuate actuator 634 to separate arms 608 and 610 as described in previous embodiments.

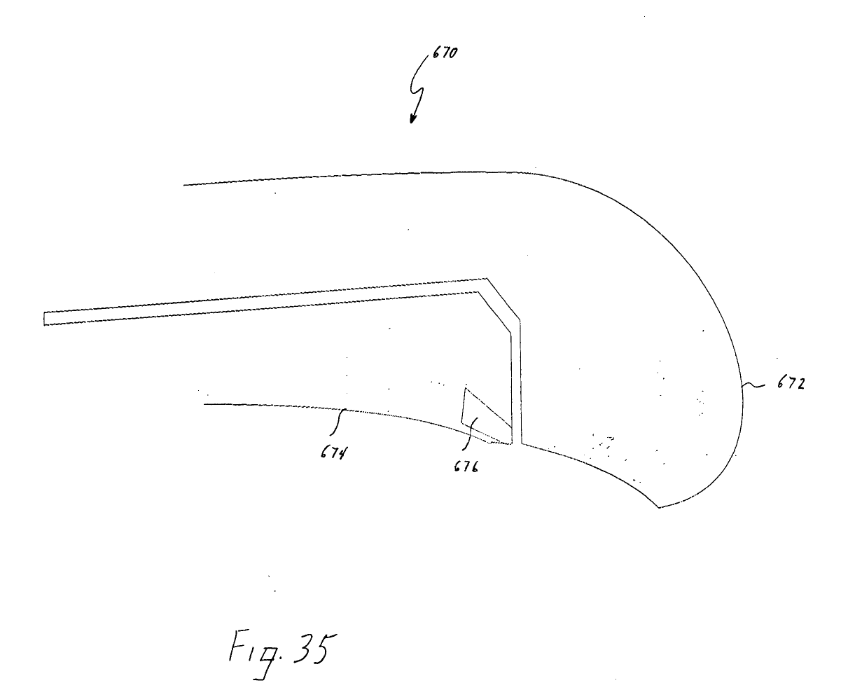

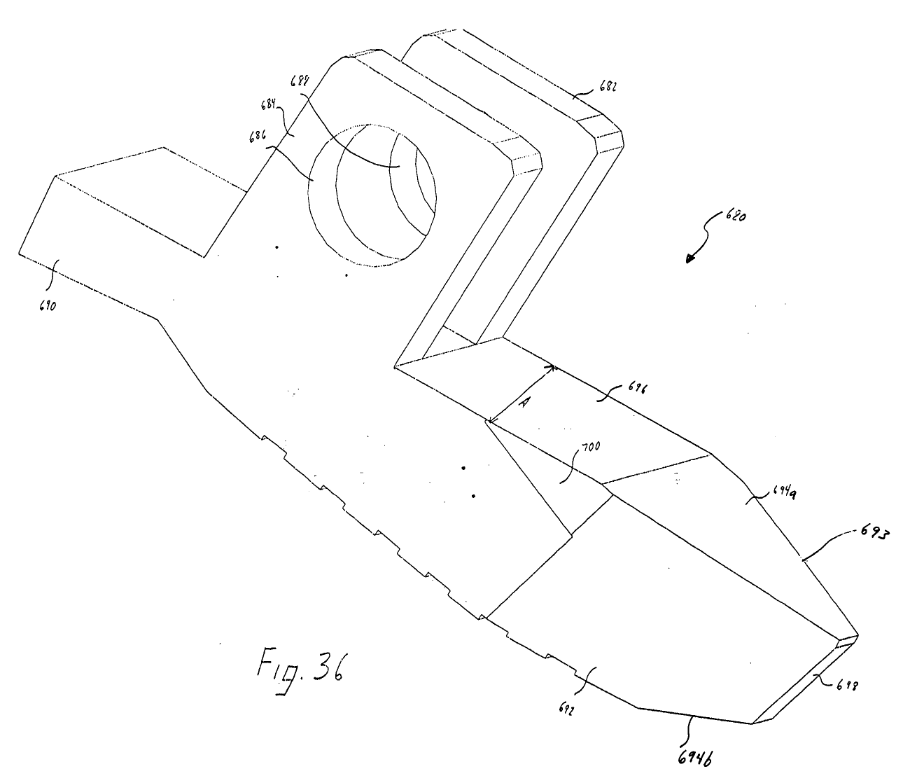

An alternative embodiment of the knife 10 of FIG. 2 is shown in FIGS. 35-39. Knife 669 is substantially similar to the embodiment of FIG. 2, except as described below. Referring to FIG. 35, liner 670 includes arm 674, which includes opening 676. Liner 671 (not shown) is a mirror image of liner 670 and also includes arm 675 with opening 677. For simplicity, only liner 671 and associated structure are described below. Actuator 680, shown in FIG. 36, includes a front end 698, an end tab 690, and a pair of tabs 682, 684 which are similar to tabs 174, 176, of FIG. 3. Tabs 682, 684 include openings 688, 686, respectively, to accept a rod 160 to couple actuator 680 to base 703 of knife blade 712. End 698 of actuator 690 is formed by side surfaces 692, 693 (only 692 is shown), a bottom surface 694a, and a top surface 694b. Side surfaces 692, 693 taper toward one another such that end 698 is narrower than width “A” of surface 696.

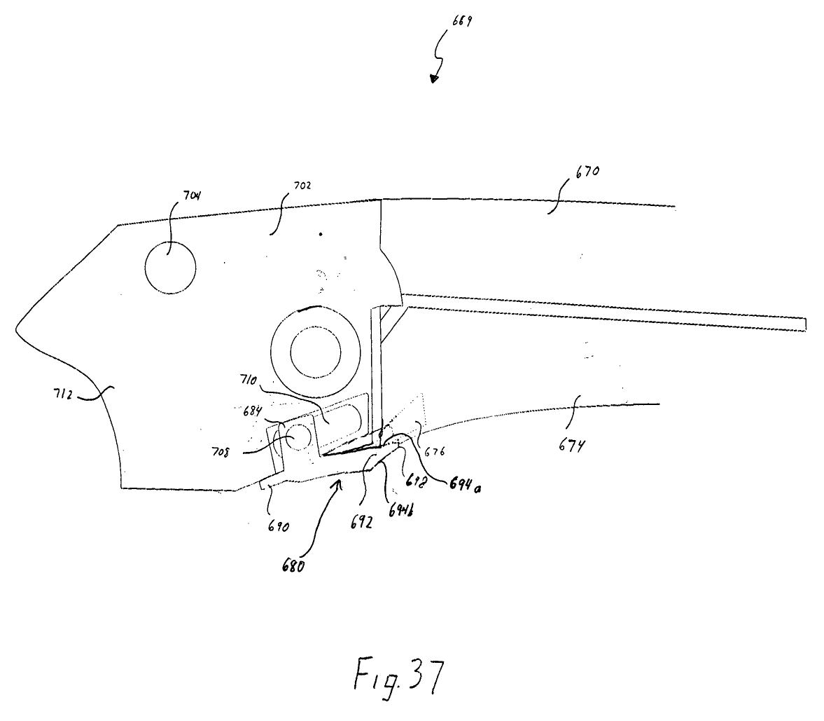

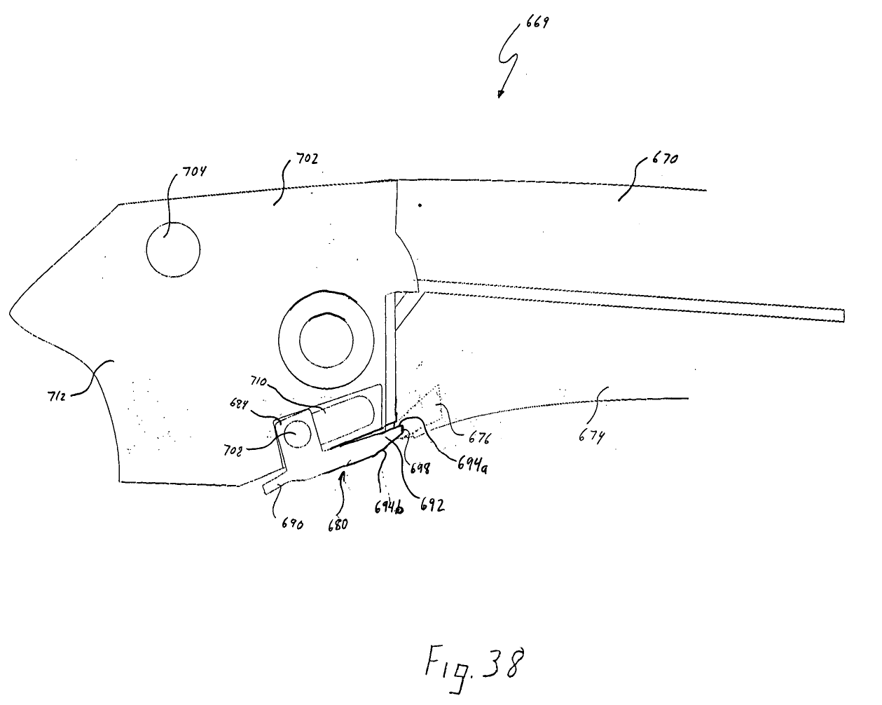

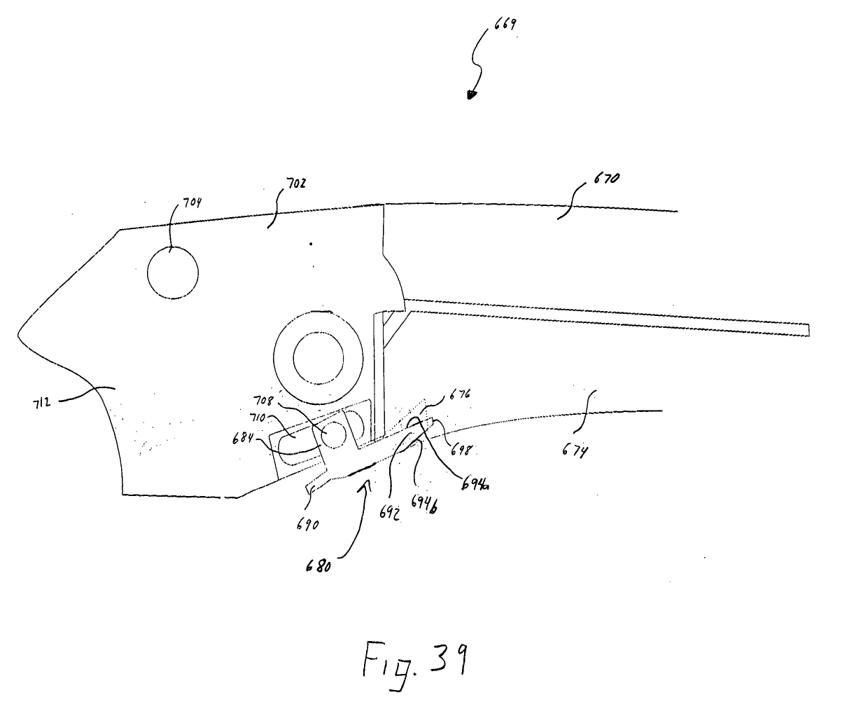

Referring to FIG. 37, knife 669 is shown in the opened position with blade 712 extended. Knife 669 includes liner 670 on one side of base 702 and liner 671 on the second side of base 702. For simplicity, only liner 670 is shown and described. Actuator 680 is secured in slot 710 of base 702 by rod 708 passing through openings 686, 688 in tabs 684, 682, respectively, and slot 710. Actuator 680 is shown in the default position in which bottom surface 694a of actuator 680 rests on a portion of arm 674 directly above opening 676. Referring now to FIG. 38, actuator 680 is shown positioned at the end of slot 710 adjacent blade 712. After the user moves actuator 680 into this position with a thumb, end 698 of actuator 680 is aligned with opening 676 of arm 674. Referring now to FIG. 39, actuator 680 is shown in opening 676. As the user moves actuator 680 into opening 676, side surface 693 of actuator 680 contact arm 674. Similarly, side surface 692 moves into an opening formed in the opposing arm. Side surfaces 692, 693 then spread the arms apart, thereby permitting blade 712 and base 702 to begin to rotate to close knife 669.

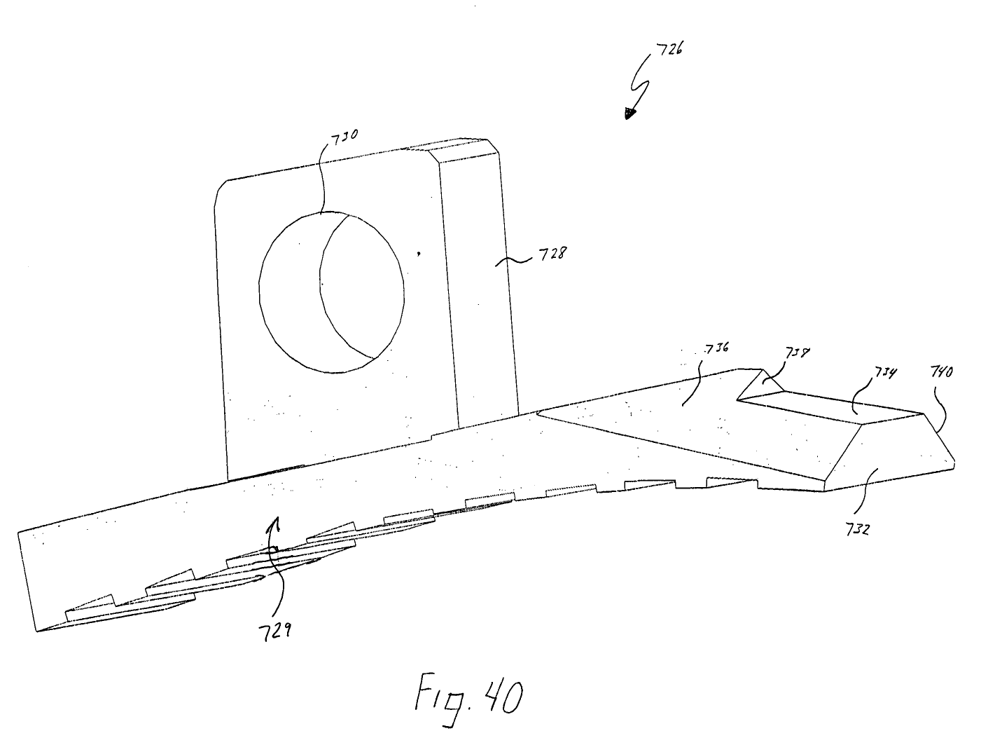

An alternative embodiment of actuator 156, shown in FIG. 2, is shown in FIG. 40. Actuator 726 is substantially similar to actuator 156 except as described below. Actuator 726 is a low-profile actuator that includes a tab 728, having an opening 730, a body 729, cam surfaces 736, 740, and bottom surface 734. Surface 738 is formed by the intersections of cam surfaces 736, 740 and bottom surface 734.

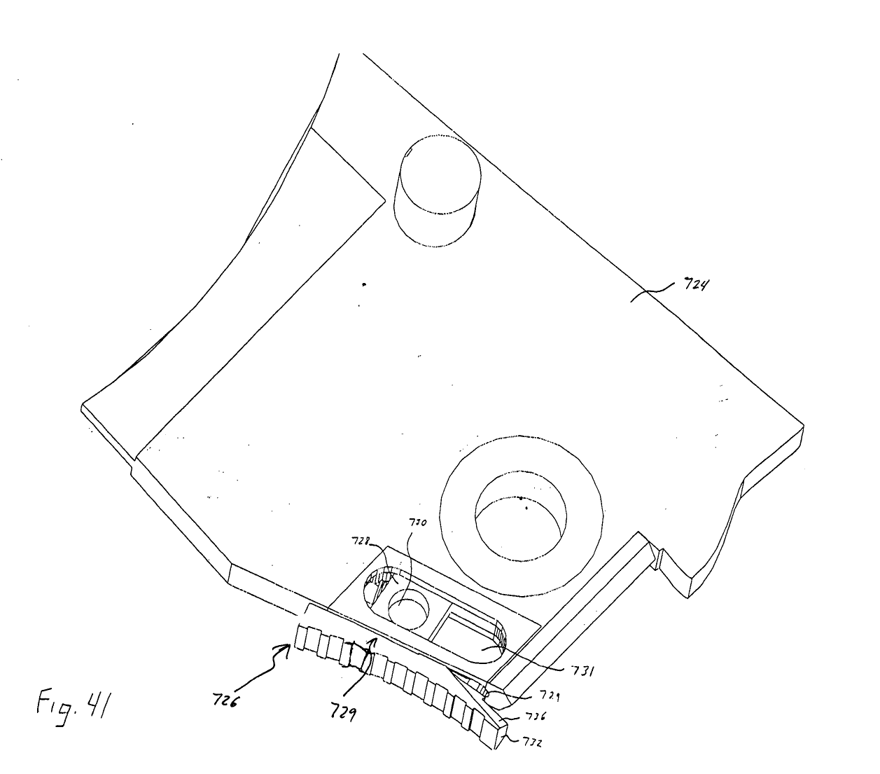

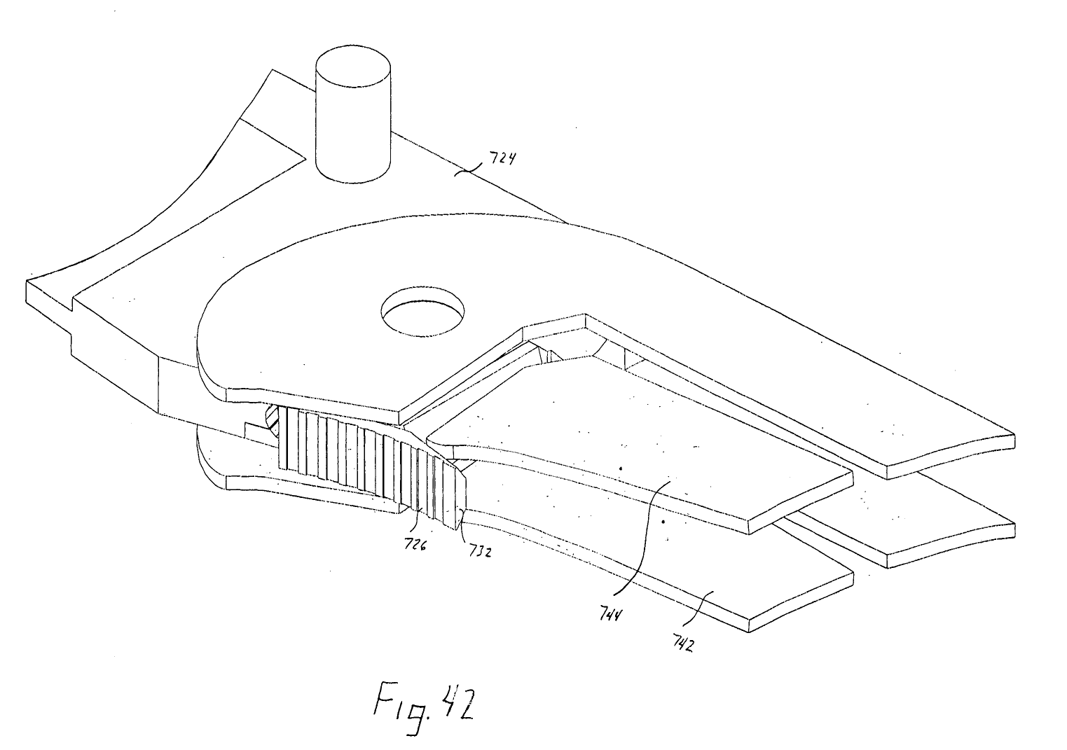

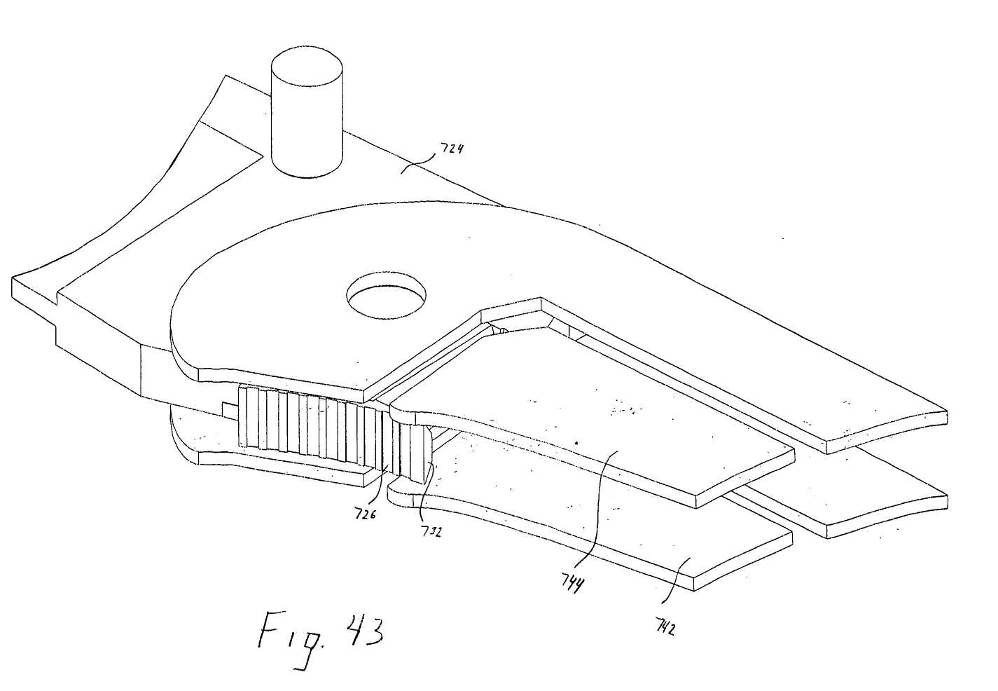

Referring to FIG. 41, low-profile actuator 726 is shown inserted into slots 729, 731 in base 724. It should be noted that low-profile actuator 726 is not as tall as actuator 156 shown in FIG. 2. The method of operation of actuator 726 is the same as that described for actuator 156 shown in FIG. 2. As shown in FIGS. 42 and 43, as low-profile actuator 726 is depressed and moved toward arms 742, 744, cam surfaces 736, 740 contact arms 742, 744 and spread the arms so that actuator 726 is positioned between the arms, thereby permitting the knife to be closed. It should be noted that low-profile actuator 726 or a similar embodiment thereof could be used in all of the described embodiments.

The foregoing description of the invention is illustrative only, and is not intended to limit the scope of the invention to the precise terms set forth. Although the invention has been described in detail with reference to certain illustrative embodiments, variations and modifications exist within the scope and spirit of the invention as described and defined in the following claims.

What is claimed:

1. A knife including:
a body;
a blade pivotally connected to the body, the blade being movable between a closed position wherein the blade is positioned substantially within the body and an open position wherein the blade is positioned substantially outside the body; and
a movable arm disposed within the body and biased toward a locking position wherein the arm locks the blade in the open position.

2. The knife of claim 1, wherein the arm moves into and out of the locking position by flexing.

3. The knife of claim 1, wherein the arm is biased against the blade when the blade is in the closed position, thereby resisting movement of the blade out of the closed position.

4. The knife of claim 1, further including a release mechanism coupled to the blade, the release mechanism including a surface for moving the arm out of the locking position, thereby permitting movement of the blade out of the open position.

5. The knife of claim 4, wherein the release mechanism is movable toward and away from the arm along a path of travel defined by the blade.

6. The knife of claim 5, wherein the path of travel is defined by a slot formed in the blade.

7. The knife of claim 6, further including a spring positioned substantially within the slot, the spring being configured to bias the release mechanism toward the body of the knife.

8. The knife of claim 7, further including a post within the slot, the spring encircling the post at one end and engaging the release mechanism at another end.

9. The knife of claim 4, wherein the release mechanism includes a spring.

10. The knife of claim 9, wherein the spring is configured to bias the release mechanism toward the body of the knife.

11. The knife of claim 10, wherein the bias supplied by the spring must be overcome to permit the release mechanism to move the arm out of the locking position, thereby permitting movement of the blade out of the open position.

12. The knife of claim 1, wherein the body includes a pair of sides, the arm being connected to one of the sides.

13. The knife of claim 12, wherein each of the sides includes a liner, the arm being connected to the liner of one of the sides.

14. The knife of claim 13, wherein the body further includes a spacer disposed between the liners to form a cavity between the liners for receiving the blade when the blade is moved to the closed position, the arm being biased into the cavity.

15. The knife of claim 12, wherein the arm is integral with the one of the sides.

16. The knife of claim 12, wherein the blade is pivotally connected to an end of the side and includes a free end that is disposed adjacent another end of the side when the blade is in the closed position.

17. The knife of claim 16, wherein the arm has a first end that is connected to one of the sides and a free end that engages a stop surface of the blade.

18. A knife including:
a body defining a cavity, the body including an arm extending into the cavity;
a blade connected to the body for rotation about a rotation axis between a closed position substantially within the cavity, and an open position substantially outside the cavity wherein the arm engages the blade, thereby locking the blade in the open position;
a release mechanism coupled to the blade for movement toward and away from the arm, the release mechanism having a cam surface for urging the arm out of engagement with the blade when the blade is in the opened position and the release mechanism is moved toward the arm; and
a first and second safety member coupled to the body, the first and second tabs configured to limit access to the release mechanism.

19. The knife of claim 18, wherein the first and second safety members are coupled to the body at positions adjacent to the release mechanism.

20. The knife of claim 18, wherein the release mechanism is in a recessed position between an upper edge of the first and second safety members, thereby limiting access to the release mechanism.

21. The knife of claim 18, wherein the first safety member is coupled to the body at a position adjacent a first side of the release mechanism and the second safety member is coupled to the body at a position adjacent a second side of the release mechanism.

22. The knife of claim 21, wherein the first and second safety members are biased to a position above the release mechanism.

23. The knife of claim 18, wherein the body includes a first and second side, the arm being connected to one of the sides.

24. The knife of claim 23, wherein the first side includes a first liner and the second side includes a second liner.

25. The knife of claim 24, wherein the first liner includes an opening configured to accept the first safety member and the second liner includes an opening configured to accept the second safety member.

26. The knife of claim 25, wherein the body further includes a spacer disposed between the first and second liners to form a cavity between the liners for receiving the blade when the blade is moved to the closed position, the arm being biased to extend into the cavity.

27. The knife of claim 26, wherein the body further includes a first and second scale, the first scale positioned on an outer side of the first liner, the second scale positioned on an outer side of the second liner.

28. The knife of claim 27, wherein the first scale includes a post configured to be positioned in a slot in the first safety member and the second scale includes a post configured to be positioned in a slot in the second safety member.

29. The knife of claim 28, wherein the slots in the first and second safety members are configured to define a path of movement of the first and second safety members from a first position limiting access to the release mechanism to a second position permitting access to the release mechanism.

30. The knife of claim 29, wherein the slots define a substantially horizontal path.

31. The knife of claim 29, wherein the slots define a substantially L-shaped path.

32. The knife of claim 29, wherein the slots define a substantially triangularly shaped path.

33. The knife of claim 29, wherein the first scales includes a first spring configured to bias the first safety member toward the first position and the second scale includes a second spring configured to bias a the second safety members toward the first position.

34. The knife of claim 33, wherein the first scales includes a recessed area configured to receive the first spring and the second scale includes a recessed area configured to receive the spring.

35. The knife of claim 34, wherein the first spring includes a first pin configured to engage a rear surface of the first safety member and the second spring including a second pin configured to engage a rear surface of the second safety member.

36. The knife of claim 35, wherein the first pin extends from the first spring into the opening in the first liner and the second pin extends from the second spring into the opening in the second liner.

37. The knife of claim 33, wherein the first safety member includes a portion configured to engage a notch in the first liner when the first safety member is in the first position and the second safety member includes a portion configured to engage a notch in the second liner when the second safety member is in the first position.

38. A knife including:
a body;
a blade pivotally connected to the body, the blade being movable between a closed position wherein the blade is positioned substantially within the body and an open position wherein the blade is positioned substantially outside the body; and
a pair of movable arms disposed within the body and biased toward one another into a locking position wherein the arms lock the blade in the open position, the arms including a first end positioned adjacent the blade in the locking position, each arm including a recessed area in a first end; and
a release mechanism coupled to the blade, the release mechanism including an end configured to enter the recessed area in the first end of the arms for moving the arms out of the locking position, thereby permitting movement of the blade out of the open position.

39. The knife of claim 38, wherein the end of the release mechanism is positioned on a portion of the arms above the recessed areas when the arms are in the locking position.

40. The knife of claim 39, wherein the release mechanism is moved toward the blade to permit the end to align with the recessed areas in the ends of the arms.

41. The knife of claim 39, wherein the release mechanism is biased towards the portion of the arms above the recessed areas when the arms are in the locking position.

42. A knife including:
a body including a pair of sides and a spacer, the spacer disposed between the sides to form a cavity between the sides;
an arm coupled to one of the sides, the arm extending into the cavity;
a blade pivotally connected to the body, the blade being movable between a closed position wherein the blade is positioned substantially within the cavity and an open position wherein the blade is positioned substantially outside the cavity and the arm engages the blade, thereby locking the blade in the open position; and
a release mechanism coupled to the blade, the release mechanism including a cam surface for urging the arm out of engagement with the blade, thereby permitting movement of the blade out of the open position.

43. The knife of claim 42, wherein the spacer includes a notch configured to engage the release mechanism when the blade is in the closed position.

44. A knife including:
a body defining a cavity, the body including an arm extending into the cavity;
a blade connected to the body for rotation about a rotation axis between a closed position substantially within the cavity, and an open position substantially outside the cavity wherein the arm engages the blade, thereby locking the blade in the open position, the blade including a first slot extending through the blade adjacent the rotation axis, and a second slot extending into the blade to intersect the first slot; and
a release mechanism coupled to the blade for movement toward and away from the arm, the release mechanism having a cam surface for urging the arm out of engagement with the blade when the release mechanism is moved toward the arm, a tab extending into the second slot of the blade so that an opening in the tab aligns with the first slot, and a rod extending through the first slot and the opening to couple the release mechanism to the blade, the slots defining a path of travel of the release mechanism toward and away from the arm.

45. The knife of claim 44, wherein the body includes a pair of arms extending into the cavity for locking the blade in the opened position.

46. The knife of claim 45, wherein the release mechanism includes a pair of cam surfaces for urging the pair of arms out of engagement with the blade when the blade is in the opened position and the release mechanism is moved toward the arms.

47. A knife including:
a body defining a cavity, the body including an arm extending into the cavity;
a blade connected to the body for rotation about a rotation axis between a closed position substantially within the cavity, and an open position substantially outside the cavity wherein the arm engages the blade, thereby locking the blade in the open position; and
a release mechanism coupled to the blade for movement toward and away from the arm, the release mechanism having a cam surface for urging the arm out of engagement with the blade when the blade is in the opened position and the release mechanism is moved toward the arm.

48. The knife of claim 47, wherein the release mechanism includes a bearing surface to which force is applied to move the release mechanism toward and away from the arm.

49. The knife of claim 47, wherein the arm is flexible.

50. The knife of claim 47 wherein the body includes a pair of sides, the arm being connected to one of the sides.

51. The knife of claim 50, wherein each of the sides includes a liner, the arm being connected to the liner of the one side.

52. The knife of claim 50, wherein the arm has one end connected to the one side and a free end that engages the blade.

53. The knife of claim 50, wherein the arm is integral with the one side.

54. The knife of claim 51, wherein the body further includes a spacer disposed between the liners to define a width of the cavity.

55. A knife including:
means for cutting being movable between a closed position and an open position; and
means connected to the cutting means for receiving the cutting means when the cutting means is in the closed position and holding the cutting means when the cutting means is in the open position, the means for receiving and holding defining a cavity and including engagement means extending into the cavity for resisting movement of the cutting means out of the closed position and locking the cutting means in the open position;
wherein the cutting means includes means for releasing the engagement means to permit movement of the cutting means out of the opened position.

56. A knife including:
a body;
a blade pivotally connected to the body, the blade being configured for movement, using either one of a left hand and a right hand, individually, between a closed position wherein the blade is positioned substantially within the body and an open position wherein the blade is positioned substantially outside the body; and
a movable arm connected to the body having an end that moves into a locking position when the blade is moved into the open position, thereby locking the blade in the open position.
